(19) United States
(12) Patent Application Publication
(10) Pub. No.: US 2020/0186810 A1
(43) Pub. Date: Jun. 11, 2020

(54) SYSTEM AND METHOD FOR OPTIMIZED VIDEO ENCODING

(71) Applicant: Beamr Imaging Ltd, Tel Aviv (IL)

(72) Inventor: Alexander ZHELUDKOV, St. Petersburg (RU)

(21) Appl. No.: 16/693,652

(22) Filed: Nov. 25, 2019

(30) Foreign Application Priority Data
Dec. 10, 2018 (RU) 2018143702

(51) Int. Cl. H04N 19/147; H04N 19/80; H04N 19/91; H04N 19/176; H04N 19/124

(52) U.S. Cl. CPC H04N 19/147; H04N 19/80; H04N 19/124; H04N 19/176; H04N 19/91

(57) ABSTRACT

There are provided computerized systems and methods of optimized video encoding. The method includes encoding a current video frame by performing an optimized quantization of transform coefficients using a modified rate-distortion cost function. The modified rate-distortion cost function can be obtained by configuring a reconstruction error in a rate-distortion cost function in accordance with a relation associated with the encoding block and the processed encoding block. In such ways, a reconstructed video frame corresponding to the current video frame has optimized perceived visual quality as compared to perceived visual quality of a reconstructed video frame of a corresponding frame bitstream which is generated without using the optimized quantization.

### TECHNICAL FIELD

The presently disclosed subject matter relates generally to the field of compression of video information, and more specifically, to methods and systems for optimized video encoding.

### BACKGROUND

The compression of video information (including, in particular, digital video information) comprises a well-known area of prior art endeavor. Generally speaking, video information compression results in a reduced set of data that consumes less memory when stored and that requires less bandwidth to transmit during a given period of time. Also, generally speaking, one goal of good compression methodologies is to achieve such benefits with minimal computational complexity while achieving a desired target size or bitrate of the compressed video stream or bitstream, and obtaining maximal perceptual quality when viewing the decompressed video sequence.

Modern video compression methodologies, such as Advanced Video Coding (AVC), also known as H.264, High Efficiency Video Coding (HEVC), also known as H.265 and MPEG-H Part 2, Google's VP9 and AOMedia Video 1 (AV1), can achieve relatively high compression rates while providing good video quality. However, as known to those skilled in the art, video compression standards set forth only the specification of compliant bitstreams and the decoding methods. These standards do not address the encoder compression efficiency and performance. As a result, some implementing platforms may operate at a technical disadvantage, due, for example, to the power-consumption requirements and/or computational requirements that attend the encoder employing the compression techniques set forth in the corresponding methodology. In addition, existing prior art approaches generally require a particular bitrate level to achieve a particular level of perceived video quality, this bitrate being higher than is desired for many application settings.

### GENERAL DESCRIPTION

In accordance with certain aspects of the presently disclosed subject matter, there is provided a computerized method of optimized video encoding, the method comprising: i) receiving a current video frame of an input video sequence to be encoded, the current video frame comprising a plurality of encoding blocks; ii) encoding the current video frame to generate a corresponding frame bitstream, comprising: for each encoding block of the plurality of encoding blocks: a) processing the encoding block using a filter, giving rise to a processed encoding block; b) computing a residual block as a difference between the encoding block and a corresponding predictor block; c) performing a frequency transform on the residual block to obtain a transformed residual block constituted by transform coefficients; d) performing an optimized quantization of the transform coefficients using a modified rate-distortion cost function, giving rise to quantized transform coefficients, wherein the modified rate-distortion cost function is obtained by configuring a reconstruction error in a rate-distortion cost function in accordance with a relation associated with the encoding block and the processed encoding block; and e) performing entropy encoding of the quantized transform coefficients to obtain a bit sequence corresponding to the encoding block; thereby giving rise to the frame bitstream comprising a plurality of bit sequences corresponding to the plurality of encoding blocks; and iii) placing the frame bitstream in an output video stream corresponding to the input video sequence, wherein upon decoding the output video stream, a reconstructed video frame corresponding to the current video frame has optimized perceived visual quality as compared to perceived visual quality of a reconstructed video frame of a corresponding frame bitstream which is generated without using the optimized quantization.

In addition to the above features, the method according to this aspect of the presently disclosed subject matter can comprise one or more of features (i) to (xi) listed below, in any desired combination or permutation which is technically possible:
(i). The processing the encoding block can be performed by applying a filter in pixel domain to the encoding block, and the encoding can further comprise: performing a frequency transform on the encoding block to obtain a transformed encoding block; and performing a frequency transform on the processed encoding block to obtain a transformed processed encoding block The relation can be computed as a function of the transformed encoding block and the transformed processed encoding block.
(ii). The processing the encoding block can be performed by performing a frequency transform on the encoding block to obtain a transformed encoding block; and applying a filter in transform domain to the transformed encoding block to obtain the transformed processed encoding block. The relation can be computed as a function between the transformed encoding block and the transformed processed encoding block.
(iii). The filter used in processing can comprise a sharpening filter usable for enhancing one or more features in the encoding block including edges.
(iv). The reconstruction error can be configured by scaling the reconstruction error by a scaling factor which is dependent on the relation.
(v). The reconstruction error can be configured by adding a difference value to the reconstruction error, wherein the difference value is calculated by: calculating a difference between transform coefficients in the transformed encoding block and the corresponding transformed processed encoding block; and clipping the difference in accordance with a quantizer step size.
(vi). The relation can be a ratio between each transform coefficient in the transformed encoding block and the corresponding transformed processed encoding block.
(vii). The predictor block can be selected from a set of candidate prediction blocks. The set of candidate prediction blocks are pixel blocks from previously encoded and reconstructed pixels belonging either to the current video frame or to a previously processed video frame in the input video sequence. The selecting can be performed so that a rate-distortion cost associated with the predictor block is the lowest among rate-distortion costs associated with the set of candidate prediction blocks.
(viii). The reconstruction error can be indicative of a difference related to the transform coefficients and corresponding de-quantized transform coefficients, and the de-quantized transform coefficients can be obtained by multiplying corresponding quantized coefficients by a quantizer step size associated therewith.
(ix). The receiving, encoding and placing can be repeated for one or more additional video frames in the input video sequence.

In accordance with another aspect of the presently disclosed subject matter, there is provided a computerized system for optimized video encoding, the system comprising: an I/O interface configured to receive a current video frame of an input video sequence to be encoded, the current video frame comprising a plurality of encoding blocks; and a control circuitry operatively connected to the I/O interface, the control circuitry comprising a processor and a memory coupled thereto and configured to: i) encode the current video frame to generate a corresponding frame bitstream, comprising: for each encoding block of the plurality of encoding blocks: a) processing the encoding block using a filter, giving rise to a processed encoding block; b) computing a residual block as a difference between the encoding block and a corresponding predictor block; c) performing a frequency transform on the residual block to obtain a transformed residual block constituted by transform coefficients; d) performing an optimized quantization of the transform coefficients using a modified rate-distortion cost function, giving rise to quantized transform coefficients, wherein the modified rate-distortion cost function is obtained by configuring a reconstruction error in a rate-distortion cost function in accordance with a relation associated with the encoding block and the processed encoding block; and e) performing entropy encoding of the quantized transform coefficients to obtain a bit sequence corresponding to the encoding block; thereby giving rise to the frame bitstream comprising a plurality of bit sequences corresponding to the plurality of encoding blocks; and ii) place the frame bitstream in an output video stream corresponding to the input video sequence, wherein upon decoding the output video stream, a reconstructed video frame corresponding to the current video frame has optimized perceived visual quality as compared to perceived visual quality of a reconstructed video frame of a corresponding frame bitstream which is generated without using the optimized quantization.

This aspect of the disclosed subject matter can comprise one or more of features (i) to (ix) listed above with respect to the method, mutatis mutandis, in any desired combination or permutation which is technically possible.

In accordance with another aspect of the presently disclosed subject matter, there is provided a non-transitory computer readable storage medium tangibly embodying a program of instructions that, when executed by a computer, cause the computer to perform a method of optimized video encoding, the method comprising: i) receiving a current video frame of an input video sequence to be encoded, the current video frame comprising a plurality of encoding blocks; ii) encoding the current video frame to generate a corresponding frame bitstream, comprising: for each encoding block of the plurality of encoding blocks: a) processing the encoding block using a filter, giving rise to a processed encoding block; b) computing a residual block as a difference between the encoding block and a corresponding predictor block; c) performing a frequency transform on the residual block to obtain a transformed residual block constituted by transform coefficients; d) performing an optimized quantization of the transform coefficients using a modified rate-distortion cost function, giving rise to quantized transform coefficients, wherein the modified rate-distortion cost function is obtained by configuring a reconstruction error in a rate-distortion cost function in accordance with a relation associated with the encoding block and the processed encoding block; and e) performing entropy encoding of the quantized transform coefficients to obtain a bit sequence corresponding to the encoding block; thereby giving rise to the frame bitstream comprising a plurality of bit sequences corresponding to the plurality of encoding blocks; and iii) placing the frame bitstream in an output video stream corresponding to the input video sequence, wherein upon decoding the output video stream, a reconstructed video frame corresponding to the current video frame has optimized perceived visual quality as compared to perceived visual quality of a reconstructed video frame of a corresponding frame bitstream which is generated without using the optimized quantization.

This aspect of the disclosed subject matter can comprise one or more of features (i) to (ix) listed above with respect to the method, mutatis mutandis, in any desired combination or permutation which is technically possible.

In accordance with yet other aspects of the presently disclosed subject matter, there is provided a computerized method of optimized video encoding, the method comprising: sequentially receiving, by an I/O interface, a current video frame from a video sequence of input video frames to be encoded, the video frame comprising luma and chroma pixel planes; partitioning each pixel plane into encoding blocks, each encoding block comprising a rectangular block of pixel values from the pixel plane, and for each encoding block: selecting an initial predictor block from a previously encoded and reconstructed pixel plane associated with a previously processed video frame in the video sequence; computing an initial residual block as the difference between the encoding block and the initial predictor block; performing a frequency transform on the initial residual block giving rise to initial residual block transform coefficients; quantizing the initial residual block transform coefficients giving rise to initial quantized transform coefficients; estimating bit consumption of initial quantized transform coefficients; calculating the rate-distortion cost associated with the initial predictor block; performing inverse quantization and inverse transform giving rise to a reconstructed initial residual block; selecting an alternative predictor block, associated with a lowest approximate rate-distortion cost among all candidate alternative predictor blocks of the initial predictor block, and wherein the approximate rate-distortion cost is calculated using the reconstructed initial residual block; completing the block encoding process, giving rise to a bit sequence comprising the bitwise representation of the encoded block, and inserting the bit sequence into the output video stream.

In addition to the above features, the method according to this aspect of the presently disclosed subject matter can comprise one or more of features (a) to (g) listed below, in any desired combination or permutation which is technically possible:
a) Calculating approximate rate-distortion cost can further comprise using the bit consumption estimate of the initial quantized transform coefficients.
b) Calculating approximate rate-distortion cost can further comprise using the bit consumption estimate of a motion vector corresponding to the candidate alternative predictor block.
c) Calculating approximate rate-distortion cost can further comprise using the distortion between the encoding block and the pixel-wise sum of the alternative predictor block and the reconstructed initial residual block.
d) Completing the block encoding process can be performed using the initial quantized transform coefficients.
e) Completing the block encoding process can further comprise using the alternative predictor block quantized transform coefficients obtained by computing a residual block, performing a frequency transform and quantizing being repeated for the alternative predictor block, after selecting the alternative predictor block.
f) Partitioning can further comprise performing the partitioning in a manner which results in square encoding blocks.
g) Partitioning can further comprise performing the partitioning so that all the encoding blocks in a pixel plane have the same dimensions.

In accordance with yet other aspects of the presently disclosed subject matter, there is provided a computerized system for optimized video encoding, the system comprising: an I/O interface configured to receive video information to be encoded, the video information comprising a sequence of video frames, and a control circuitry operatively connected to the I/O interface, the control circuitry comprising a processor and a memory coupled thereto and configured to encode a pixel plane of a video frame of said sequence, by passing the pixel plane to a partitioning module to obtain a set of encoding blocks, and then for each encoding block: activating the initial predictor selector to obtain an initial prediction block comprising prediction pixels and initial Motion Vector (MV) indicating initial prediction block relative coordinates; providing the initial predictor block to the transform and quantize module to obtain initial quantized transform coefficients; providing initial quantized transform coefficients to Rate estimator to obtain initial coefficient rate estimation; providing the inverse and transform module with quantized transform coefficients and to obtain the initial reconstructed residual block; providing the residual and predictor combiner with the reconstructed residual block and a prediction block to obtain a reconstructed block; providing the reconstructed block to the distortion(s) estimator to obtain at least one distortion estimation; Providing the Motion Vector to the Rate estimator to obtain the MV rate estimation; calculating the modified rate distortion according to the calculated rate and distortion values and providing the cost to the Decider; then, for each candidate alternative predictor corresponding to an alternative Motion Vector and alternative prediction block, the system is configured to repeat the providing the residual and predictor combiner, providing the reconstructed block to the distortion(s) estimator, providing the Motion Vector to the Rate estimator and calculating the modified rate distortion, for each candidate alternative predictor corresponding to an alternative Motion Vector and alternative prediction block. The system further comprises a decider module which performs selection of the Motion Vector corresponding to the optimal predictor candidate and residual to encode, and an entropy encoding module which performs encoding of block data giving rise to a bit sequence, which is inserted into the output video stream.

This aspect of the disclosed subject matter can comprise one or more of features (a) to (g) listed above with respect to the method, mutatis mutandis, in any desired combination or permutation which is technically possible.

In accordance with yet other aspects of the presently disclosed subject matter, there is provided a computerized method for optimized video encoding, which uses rate-distortion functions for decisions during encoding of an encoding block, and further comprising a modified rate-distortion cost calculator, wherein the modified rate-distortion calculation is obtained by computing a first complexity value associated with an encoding block, setting scaling factors according to this first complexity value, calculating the reconstructed block distortion values and adapting the rate-distortion functions used by the encoder by applying the scaling factors to the block distortion values.

In addition to the above features, the method according to this aspect of the presently disclosed subject matter can comprise one or more of features (1) to (6) listed below, in any desired combination or permutation which is technically possible:
(1) The first complexity may be computed according to the coefficients of a discrete Hadamard transform of the encoding block, or sub-blocks thereof.
(2) The first complexity may be set to the maximum among the sum of absolute values of the AC coefficients of the discrete Hadamard transform of each 8×8 sub-block of the encoding block.
(3) The scaling factors can be obtained by mapping the first complexity value using one or more piecewise linear functions.
(4) The scaling factors can be obtained by mapping the first complexity value using one or more piecewise linear functions, wherein at least one of these linear functions is monotonically non-decreasing for low complexity values and monotonically non-increasing for high complexity values.
(5) The scaling factors can be obtained by mapping the first complexity value using one or more piecewise linear functions, wherein at least one of said functions is monotonically non-increasing for low complexity values and monotonically non-decreasing for high complexity values.
(6) The rate distortion function used by the encoder can comprise three components: A rate component, a first block distortion component related to the pixel-wise difference between encoding block and reconstructed block, and a second block distortion component related to differences between transformed versions of encoding block and reconstructed block, and wherein the method can further comprise applying a different scaling factor to each of the block distortion components.

In accordance with yet another aspect of the presently disclosed subject matter, there is provided a non-transitory computer readable storage medium tangibly embodying a program of instructions that, when executed by a computer, cause the computer to perform the method steps of any of the methods disclosed above.

### BRIEF DESCRIPTION OF THE DRAWINGS

The above needs are at least partially met through provision of the apparatus and method for optimized video encoding described in the following detailed description, particularly when studied in conjunction with the drawings.

In order to understand the presently disclosed subject matter and to see how it may be carried out in practice, embodiments will now be described, by way of non-limiting example only, with reference to the accompanying drawings, in which:

FIG. 1 illustrates a block diagram of a computerized system for optimized video encoding in accordance with certain embodiments of the presently disclosed subject matter;

FIGS. 2 and 2B illustrate block diagrams of a computerized system for optimized quantization in accordance with certain embodiments of the presently disclosed subject matter;

FIG. 3 illustrates a block diagram of a computerized system for optimized motion vector refinement in accordance with certain embodiments of the presently disclosed subject matter;

FIG. 4 illustrates a block diagram of a computerized system for optimized Rate-Distortion calculation in accordance with certain embodiments of the presently disclosed subject matter;

FIG. 5 illustrates a generalized flowchart of optimized video encoding in accordance with certain embodiments of the presently disclosed subject matter;

FIGS. 6 and 6B illustrate a generalized flowchart of optimized motion vector refinement in accordance with certain embodiments of the presently disclosed subject matter;

FIG. 7 illustrates a generalized flowchart of complexity-based Rate-Distortion estimation in accordance with certain embodiments of the presently disclosed subject matter;

FIG. 8 illustrates an example of optimized quantization computations performed in accordance with certain embodiments of the present invention.

FIG. 9A FIG. 9E illustrate examples of blocks of varying complexity and their corresponding scale factors in accordance with certain embodiments of the presently disclosed subject matter.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have their ordinary technical meaning as are accorded to such terms and expressions by persons skilled in the technical field as set forth above, except where different specific meanings have otherwise been set forth herein.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “receiving”, “encoding”, “processing”, “calculating”, “computing”, “estimating”, “configuring”, “filtering”, “obtaining”, “generating”, “using”, “extracting”, “performing”, “placing”, “adding”, “partitioning”, “applying”, “comparing”, “sharpening”, “scaling”, “calculating”, “clipping”, “multiplying”, “repeating”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the system/apparatus and parts thereof as well as the control circuit/circuitry therein disclosed in the present application.

The terms “non-transitory memory” and “non-transitory storage medium” used herein should be expansively construed to cover any volatile or non-volatile computer memory suitable to the presently disclosed subject matter.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the following detailed description, numerous specific details are set forth in order to provide a thorough understanding of the methods and apparatus.

Generally speaking, pursuant to these various embodiments, an apparatus has an input configured to receive video information and an output configured to provide an output video stream. The apparatus includes a control circuit operably coupled to the foregoing input and output and configured to perform optimized video encoding. It will be noted that some of the encoding operations described herein do not relate to the novel aspects of the invention, but are provided for the sake of completeness and clarity.

By one approach, the control circuit is configured to perform optimized quantization of the transform coefficients associated with the encoding block. In one of the steps of hybrid block-based encoders, transform coefficients are quantized prior to encoding into the bitstream. The control circuit described herein can be configured to perform the quantizing using quantization rate-distortion functions which utilize modified reconstruction errors, wherein the modification is according to a relation between the encoding block and a processed version of the encoding block.

By another approach, in lieu of the foregoing or in combination therewith, the control circuit is configured to perform optimized INTER predictor selection, or Motion Vector (MV) refinement. In one of the steps of hybrid block-based encoders, when performing inter-frame prediction, the encoder seeks an optimal MV, corresponding to an optimal predictor, for the encoding block. After an initial predictor has been selected by the encoder, for example using coarse motion-estimation with a method known by those skilled in the art, the control circuit described herein can be configured to select an alternative predictor block associated with a lowest approximate rate-distortion cost among all candidate alternative predictor blocks of the initial predictor block, wherein the approximate rate-distortion cost is efficiently calculated using the reconstructed initial residual block.

By yet another approach, in lieu of the foregoing or in combination therewith, the control circuit is configured to perform optimized encoding by using modified rate-distortion calculations. The control circuit described herein can be configured to compute a first complexity value associated with the encoding block, and set scaling factors according to the first complexity value, and upon calculating reconstructed block distortion values, adapting the rate-distortion functions by applying the scaling factors to the block distortion values.

Using one or more of the aforementioned techniques, video information can be processed in a way that can greatly reduce the computational and/or bitrate requirements of the resulting compressed video bitstream. In particular, many prior art compression methodologies, including the recent HEVC standard, can be carried out in a considerably more efficient and less computationally-intensive manner. As a result, use of these teachings can reduce power requirements and/or can reduce the computational overhead requirements of the implementing encoder hardware while also possibly reducing the necessary bitrate. More importantly, these teachings permit a lower bitrate to be utilized than previous approaches while maintaining at least a similar level of perceptible quality and can also achieve a higher level of perceptible quality at a given bitrate than existing approaches. These and other benefits may become clearer upon thorough review and study of the following detailed description.

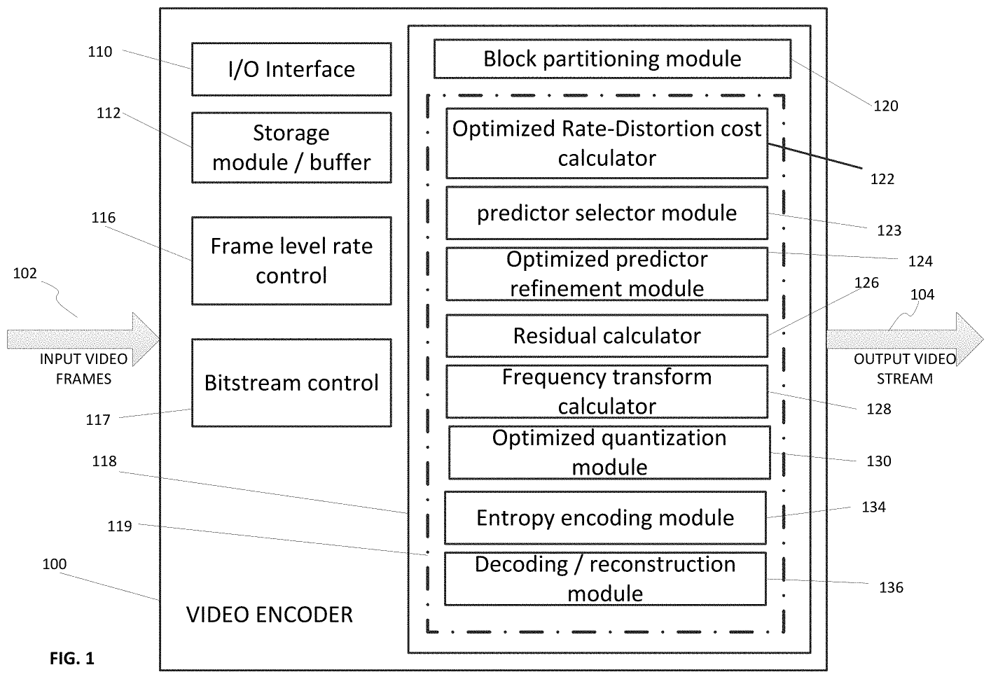

Referring now to the drawings, FIG. 1 illustrates a block diagram of a computerized system for optimized video encoding in accordance with certain embodiments of the presently disclosed subject matter;

There is presented an enabling computer-based apparatus/system 100 configured to perform optimized video encoding.

System 100 can comprise a control circuitry (also termed herein as control circuit, not shown separately) operating jointly with a hardware-based I/O interface 110 and a storage module or buffer 112. The system 100 may obtain, e.g., via I/O interface 110, video information to be encoded, the video information comprising a sequence of video frames (also termed herein as frames or input frames). In some embodiments, the input video information or the video frames thereof can be received from a user, a third-party provider or any other system that is communicatively connected with system 100. Alternatively, or additionally, the input video information or the video frames thereof can be pre-stored in the storage module or buffer 112.

The control circuitry is a processing circuitry configured to provide all processing necessary for the required blocks, which are further detailed below. The control circuitry refers to hardware (e.g., an electronic circuit) within a computer that executes a program. The control circuitry can comprise a processor (not shown separately) and a memory (not shown separately). The processor of system 100 can be configured to execute several functional modules in accordance with computer-readable instructions implemented on a non-transitory computer-readable memory comprised in the control circuitry. Such functional modules (such as, e.g., the video encoding module 118, or any modules included therein) are referred to hereinafter as comprised in the control circuitry.

According to certain embodiments, a “circuit” or “circuitry” can include a structure that includes at least one (and typically many) electrically-conductive paths (such as, e.g., paths comprised of a conductive metal such as copper or silver) that convey electricity in an ordered manner, whose path(s) will also typically include corresponding electrical components (both passive, such as, e.g., resistors and capacitors, and active, such as, e.g., any of a variety of semiconductor-based devices, as appropriate) to permit the circuit to effect the control aspect of these teachings.

Such a system 100 can comprise a fixed-purpose hard-wired hardware platform (including but not limited to, e.g., an application-specific integrated circuit (ASIC) which is an integrated circuit that is customized by design for a particular use, rather than intended for general-purpose use, a field-programmable gate array (FPGA), and the like) or can comprise a partially or wholly-programmable hardware platform (including but not limited to, e.g., microcontrollers, microprocessors, and the like). If desired, the system 100 can comprise an integral part of a dedicated video encoder integrated circuit which can implement the functionalities of the functional module-video encoding module 118, as will be described below. The system 100 can be configured (for example, by using corresponding programming as will be well understood by those skilled in the art) to carry out one or more of the steps, actions, and/or functions described herein.

As aforementioned, the system 100 can comprise a processor and a memory. By one approach the system 100 can be operably coupled to the memory. This memory may be integral to the control circuitry or can be physically discrete (in whole or in part) from the control circuitry as desired. This memory can also be local with respect to the control circuitry (where, for example, both share a common circuit board, chassis, power supply, and/or housing) or can be partially or wholly remote with respect to the control circuitry (where, for example, the memory is physically located in another facility, metropolitan area, or even country, as compared to the control circuitry).

In addition to other useful information described herein, this memory can serve, for example, to non-transitorily store the computer instructions that, when executed by the control circuitry, cause the control circuitry to behave as described herein. As used herein, the reference to “non-transitorily” will be understood to refer to a non-ephemeral state for the stored contents (and hence excludes when the stored contents merely constitute signals or waves) rather than volatility of the storage media itself and hence includes both non-volatile memory (such as e.g., read-only memory (ROM)) as well as volatile memory (such as, e.g., an erasable programmable read-only memory (EPROM)).

As aforementioned, the I/O interface 110 (also referred to herein separately as input interface and output interface or input and output) is operably coupled to the system 100 and is configured to receive video information to be encoded, the video information comprising a sequence of video frames, as well as to output a compressed or encoded video stream or bitstream.

The teachings herein will accommodate receiving video information in any of a wide variety of formats. In a typical application setting, the video information can constitute digital content. By one approach, if desired, the original video content can have an analog format and can then be converted to a digital format to constitute the video information.

As noted above, the received video information is “to be compressed”. By one approach the video information refers to any original video content that has not been compressed in any way, aside from some optional inherent compression that might occur during the digitization process, such as, e.g., an original raw video clip or part thereof. Such a video clip can comprise a plurality of original video frames, and can be obtained from, e.g., a digital camera or recorder, or any other suitable devices that are capable of capturing or recording individual still images or sequences of images constituting videos or movies. By another approach, the video information may already have undergone some compression but, if so, is still nevertheless to be compressed again via the video encoding module 118 (also referred to as video frame encoder). In such cases, video bit-stream (also referred to as video bitstream or video stream) that contains encoded data can be first decoded or reconstructed to a decoded video sequence prior to being further processed using the present disclosure. The input video information can comprise the decoded or reconstructed video sequence which was decoded from the encoded video bit-stream. In this case, the compression refers to recompression of the video information. Without limiting the scope of the disclosure in any way, it should be noted that the term “frame” used in the specification should be expansively construed to include a single video picture, frame, image, field, or slice of the input video sequence.

The terms Rate-Distortion, RD, rate-distortion, and Rate-Distortion cost, RD cost, RDcost and RdCost may be interchangeably used herein. As known to those skilled in the art of video compression, rate-distortion cost uses a cost function which combines estimated rate or bits required when encoding certain data in a specific manner, with a measure of distortion which this specific manner of encoding will introduce to the corresponding reconstructed data. Generally speaking, encoders aim to minimize the RD cost to obtain the best possible quality at the lowest possible rate. Different forms of RD cost functions will result in different encoding decisions, and hence different bitrate of the compressed video stream and/or different quality of the reconstructed video obtained when decoding said video stream.

According to certain embodiments the system 100 may receive as input a sequence of input video frames, or a single video frame from such a sequence 102. Each video frame may correspond to one or more pixel planes. For example, each frame may consist of one luminance or luma plane and two chrominance or chroma planes. The system 100 may further provide as output an output video stream 104, or bitstream, containing the bits corresponding to the compressed input frame or frames, i.e. a bitstream, which when fed into a corresponding decoder, will result in reconstructed video frames which are similar to the input video frames.

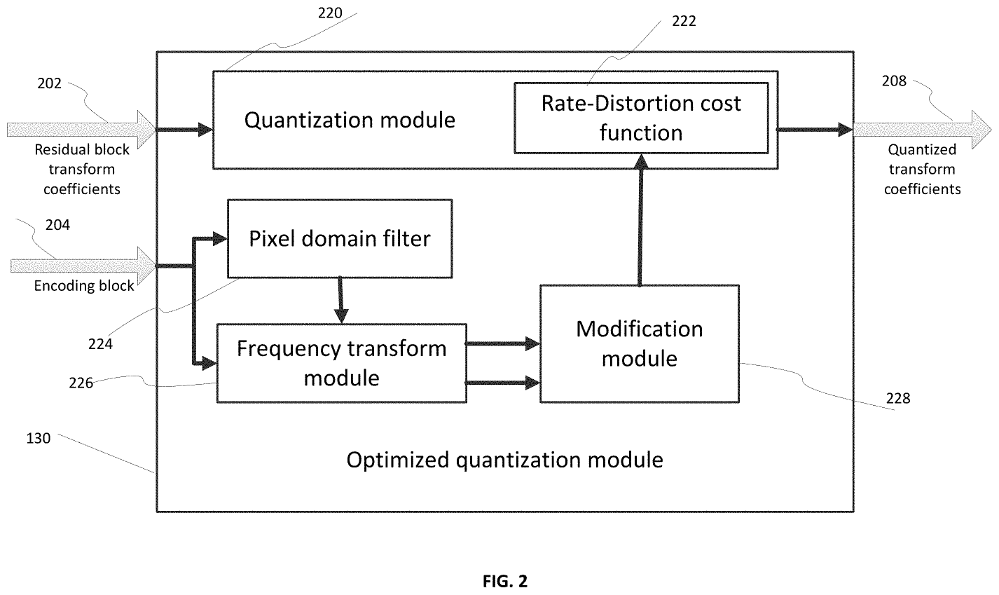

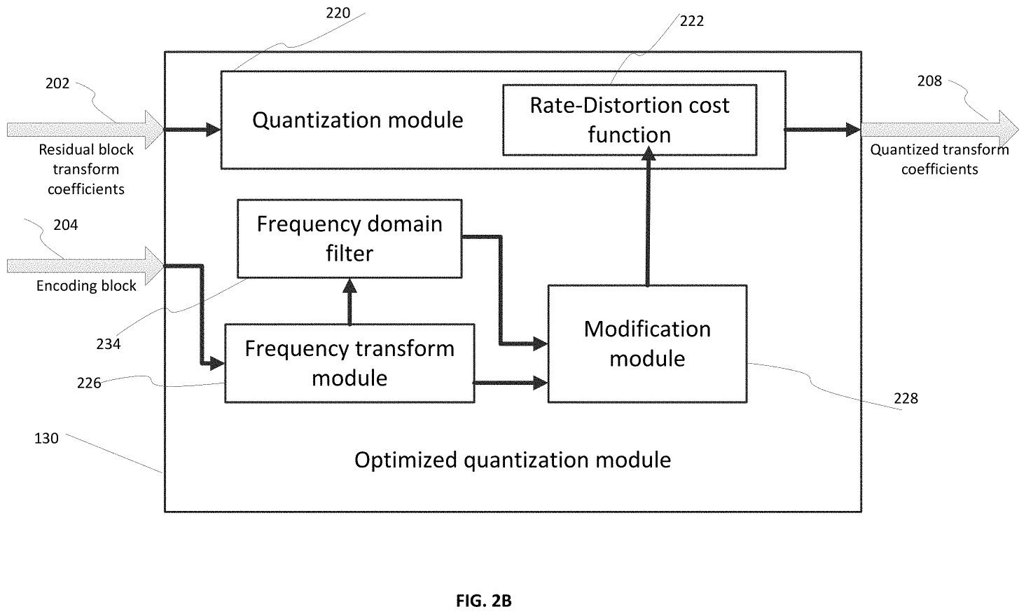

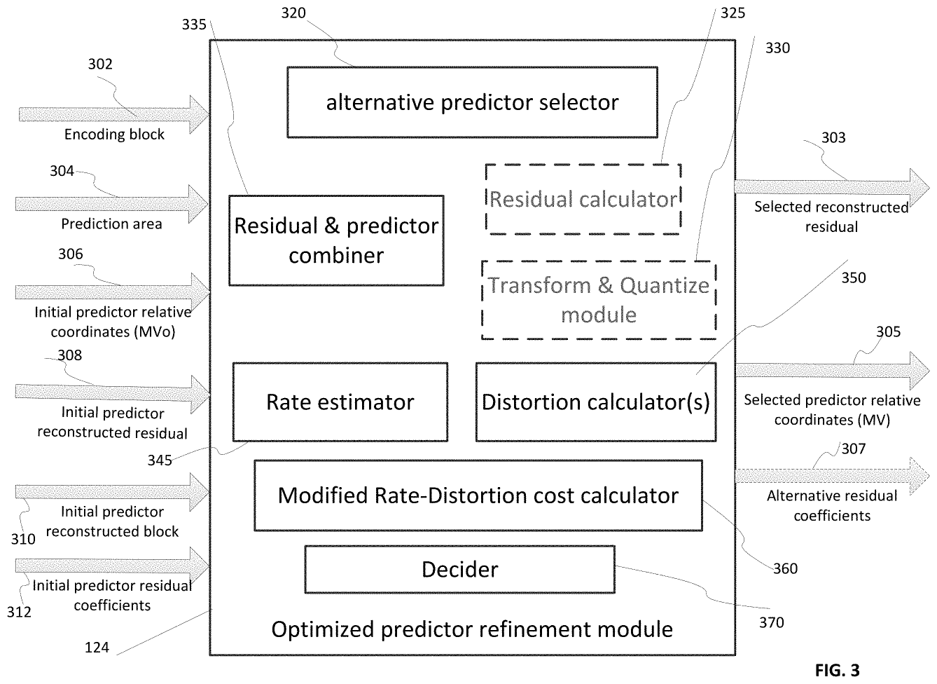

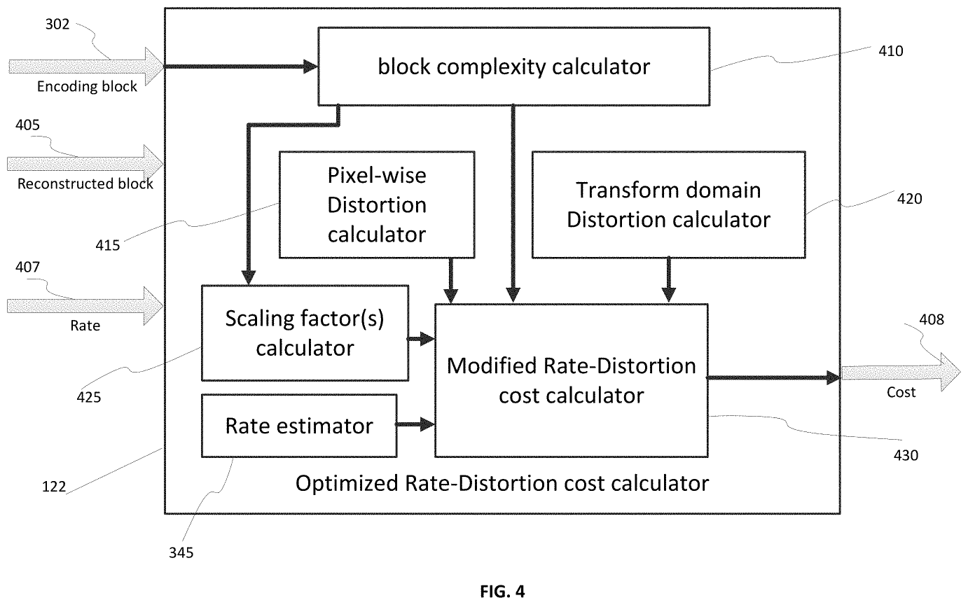

According to certain embodiments, functional modules comprised in the processor of the system 100 can comprise a frame level rate control module 116, a bitstream control module 117, and a video frame encoder 118 which are operatively connected with each other. The frame level rate control module 116 is used, as known by those skilled in the art, to configure the video frame encoder, and set parameters such as frame type and frame bit allocation or quantization parameters. The bitstream control module manages the bitstream creation and receives, as input, data and bit sequences from the frame level rate control module 116 and the video frame encoder 118. The video frame encoder 118 can be configured to perform optimized video encoding in various ways as described herein. The block partitioning module 120 splits the frame into coding blocks such as Macro-Block or Coding Units. Note that in most coding standards and techniques further sub-partitioning of these coding blocks is also supported. In this description the terms a coding block or encoding block are used to describe either the entire coding block or sub blocks thereof, and do not provide any distinction between them for the purpose of the present teachings. For each coding block, all or some of the modules described in the block coding module 119 are invoked. These include, but are by no means limited to, the optimized rate distortion cost calculator 122 described with reference to FIG. 4, a predictor selector module 123 configured to select an INTRA or INTER prediction block for the encoding block, an optimized predictor refinement module 124 described with reference to FIG. 3, a residual calculator 126 configured to obtain the residual block given the encoding block and the predictor block, a frequency transform calculator 128 configured to convert the pixel domain (residual) to the transform domain often using a DCT like transform, an optimized quantization module 130 described with reference to FIG. 2, an entropy encoding module 134 configured to perform entropy coding of the coding block information comprising header information such as prediction mode and Motion Vector, and block residual quantized transform coefficients, giving rise to a bit sequence which represents the coding block, and a decoding/reconstruction module 136 which reconstructs the block in the same manner as is done in the corresponding video decoder, so that the reconstructed blocks may be used as reference data in future predictions. Further details on the novel modules will be provided with respect to FIGS. 2-9. The teachings described with respect to FIGS. 2-9 can be implemented by the video frame encoder 118 either separately in different embodiments, or in any appropriate combination thereof. For example, the optimized quantization module 130 can be configured to perform quantization wherein the quantization rate-distortion functions used in the quantizing are based on modified reconstruction errors, the modification being according to a relation between the encoding block and a processed version of the encoding block as described with reference to FIG. 2, and/or by using optimized Motion Vector refinement, i.e. optimized predictor refinement module 124 as described with reference to FIG. 3, and/or by using optimized rate-distortion function calculator 122 for instance when determining the encoding block encoding mode as described with reference to FIG. 4. As aforementioned, by using the optimized modules, it can greatly reduce the computational and/or bitrate requirements of the encoding operation, thereby enabling a considerably more efficient and less computationally-intensive video encoding.

Those skilled in the art will be familiar with a wide variety of video encoders and compression techniques employing frame level rate control, block partitioning, initial predictor selection, residual calculation, frequency transform calculation, entropy encoding and decoding or reconstruction. As the present teachings are not especially sensitive to any particular choices in this regard, no further elaboration is provided here.

The storage module or buffer 112 comprises a non-transitory computer readable storage medium. For instance, the storage module can include a buffer that holds the input video information as well as an output video sequence. In another example, the buffer may also hold one or more of the intermediate results including but not limited to previously encoded and reconstructed blocks, pixel planes or video frames. According to certain embodiments, the storage module or buffer 112 can also comprise computer-readable instructions embodied therein to be executed by the system 100 for implementing the process of optimized video encoding as described below with reference to FIGS. 2-9.

Those versed in the art will readily appreciate that the teachings of the presently disclosed subject matter are not bound by the system illustrated in FIG. 1 and the above exemplified implementations. Equivalent and/or modified functionality can be consolidated or divided in another manner and can be implemented in any appropriate combination of software, firmware and hardware. By way of example, the functionalities of the frame encoding module 118 as described herein can be divided and implemented as separate modules operatively connected to system 100. For instance, the frame encoding module 118 can be either implemented as integrated within the control circuitry, or alternatively as a separate module operatively in connection with the control circuitry.

The system in FIG. 1 can be a standalone network entity, or integrated, fully or partly, with other network entities. Those skilled in the art will also readily appreciate that the storage unit and/or therein can be shared with other systems or be provided by other systems, including third party equipment.

It is also noted that the system illustrated in FIG. 1 can be implemented in a distributed computing environment, in which the aforementioned functional modules shown in FIG. 1 can be distributed over several local and/or remote devices, and can be linked through a communication network.

While not necessarily so, the process of operation of system 100 can correspond to some or all of the stages of the methods described with respect to FIGS. 2-9. Likewise, the methods described with respect to FIGS. 2-9 and their possible implementations can be implemented, either separately or in any suitable combination, by system 100. It is therefore noted that embodiments discussed in relation to the methods described with respect to FIGS. 2-9 can also be implemented, mutatis mutandis as various embodiments of the system 100, and vice versa.

Turning now to FIG. 2, there is illustrated a block diagram of a computerized system for optimized quantization in accordance with certain embodiments of the presently disclosed subject matter. An encoding block 204 and residual block transform coefficients 202 (i.e., a transformed residual block constituted by transform coefficients) which are obtained as output from the frequency transform calculator 128 can be received as input to the optimized quantization module 130. The encoding block comprises a set of pixel values from a pixel plane belonging to the current video frame of the input video frames 102. The encoding block is processed, for example by applying a filter (e.g., pixel domain filter 224). The filter can be used for the purpose of enhancing certain features in the current video frame which are preferred to be retained in the encoding process, such as, e.g., edges, etc. For example and without limitation, a linear filter can be applied to the encoding block, such as, e.g., sharpening, high-pass filtering, low-pass filtering, smoothing, edge enhancement, etc. giving rise to a processed encoding block. Then both the encoding block 204 and the processed encoding block are passed to the frequency transform module 226, which applies some frequency transform to an encoding block and creates a transformed encoding block and a transformed processed encoding block each constituted by corresponding transform coefficients. The transform coefficients of each of the transformed encoding block and the transformed processed encoding block are then provided to a modification module 228. The modification module uses a relation associated with the encoding block and the processed encoding block, e.g., a relation between the two sets of transform coefficients to configure or modify the Rate-Distortion cost function 222 used within the quantization module 220 (also referred to as quantization rate-distortion cost function). For example, in one embodiment, the modification module may calculate a ratio between each pair of corresponding transform coefficients. In yet another embodiment, the modification module may calculate a difference value between each two corresponding transform coefficients. In yet another embodiment, the modification module may calculate any per frequency coefficient function using one or more of each of the transform coefficients in the encoding block and the corresponding processed block. In a further example, the modification module may calculate more than one relation per corresponding coefficient pair and provide one or more values per coefficient to the quantization module, or more specifically, to the rate-distortion cost function module within the quantization module. In yet another example, the relation may be directly between the encoding block and the processed encoding block (i.e., between the pixel values of these two blocks).

Turning now to FIG. 2B, there is illustrated another block diagram of a computerized system for optimized quantization in accordance with certain embodiments of the presently disclosed subject matter. In this embodiment, an encoding block 204 and residual block transform coefficients 202 which are obtained as output from the frequency transform calculator 128 can be received as input to the optimized quantization module 130. The encoding block comprises a set of pixel values from a pixel plane belonging to the current video frame of the input video frames 102. The encoding block 204 is passed to the frequency transform module 226, which applies some frequency transform to the encoding block and creates a transformed encoding block of transform coefficients. These coefficients are provided to a filter (e.g., the frequency domain filter 234, also referred to as transform domain filter), which performs a filtering operation on the encoding block such as, e.g., sharpening, high-pass filtering, low-pass filtering, smoothing, edge enhancement, etc. giving rise to a transformed processed encoding block constituted by corresponding transform coefficients. The transform coefficients in each of the transformed encoding block and the transformed processed encoding block are then provided to the modification module 228. The modification module uses a relation associated with the encoding block and the processed encoding block, e.g., a relation between the two sets of transform coefficients in the transformed encoding block and the transformed processed encoding block to configure or modify the Rate-Distortion cost function 222 used within the quantization module 220, for example as described above regarding FIG. 2.

Turning now to FIG. 3, there is illustrated a block diagram of a computerized system for optimized motion vector refinement in accordance with certain embodiments of the presently disclosed subject matter. The optimized predictor refinement module 124 receives as inputs the encoding block 302 consisting for example of the pixels to be encoded, a prediction area 304 consisting for example of a pixel area in a reference frame from which the prediction block is to be selected, an initial predictor block Motion Vector, or MV, or relative coordinates or offset 306 which, as known to those skilled in the art, indicate the location within the prediction area corresponding to the initial prediction block which is represented for example by delta-x and delta-y values describing the horizontal and vertical offset in pixels of the prediction block in a reference frame compared to the location in the current frame of the encoding block. This initial MV, which may be denoted as MVo, may be received for example from the predictor selector module 123. The optimized predictor refinement module 124 also receives as input the initial predictor reconstructed residual 308 which may be denoted as Rrec(MVo). This, in turn, can be received for example as the output of the decoding/reconstruction module 136 when applied to the block obtained from applying the residual calculator 126 to the encoding block and the initial predictor block, followed by the frequency transform calculator 128 and optimized quantization module 130. The optimized predictor refinement module 124 may also receive as input the initial predictor reconstructed block 310 which may be denoted as Prec(MVo), which can be received for example as the output of the decoding/reconstruction module 136 when combining the reconstructed residual of the initial predictor to the initial predictor block. The optimized predictor refinement module 124 may also receive as input the initial predictor residual coefficients 312 which may be denoted as Cq(MVo). The optimized predictor refinement module 124 processes the input data as described herein creating as output a selected reconstructed residual block 303 and a selected predictor block relative coordinates 305 both to be used for encoding the encoding block 302 for example by entropy encoding module 136. Optionally the optimized predictor refinement module 124 may also provide as output alternative residual coefficients 307.

One possible embodiment of the optimized predictor refinement module 124 will now be provided. First, an initial Rate-Distortion cost associated with the initial predictor is calculated. This is performed using the rate estimator 345, a module which for some x provides an estimated bit consumption resulting from entropy encoding of x, which may be denoted as B(x), the distortion(s) calculator 350, a module which for two inputs y1, y2, provides an estimate of the distortion between these two inputs which may be denoted as D(y1, y2), and the modified Rate-Distortion calculator 360, which given a bit estimation B and one or more distortion values D calculates a RD cost, for example using a Lagrange multiplier format such as RDcost=λB+D. For calculating the initial RD cost the rate estimator is applied to the initial predictor residual coefficients Cq(MVo) and the initial MV, while the distortion calculator is applied to the encoding block and the initial predictor reconstructed block. This yields a RDcost values associated with the initial predictor. The goal of the optimized predictor refinement module is to find an alternative predictor which yields a lower RDcost. The often-adopted approach to address this is to evaluate candidate alternative predictors by repeating the full process of obtaining predictor, calculating the residual, applying frequency transform followed by quantization, inverse quantization and inverse transform, thus obtaining a candidate reconstructed residual, and using this data to calculate the rate distortion of the proposed candidate predictor. The disadvantage of this approach is primarily the abhorrent computational cost of this task, leading either to slow or computationally demanding encoding, or to poorer compression efficiency if the refinement process of choosing an improved predictor is precluded or constrained. In the approach proposed herein this may be overcome by performing the proposed optimized refinement process. The alternative predictor selector provides selected candidates of the alternative prediction block. These candidates depend on the configuration of the selector but may, for example, in one embodiment, consist of all predictors associated with a candidate motion vector MVj which are close to the initial motion vector MVo, for example MVj=MVo+delta_j wherein delta_j may indicate positive or negative increase in either the horizontal or vertical motion vector components, or in both. For each such alternative predictor, the following steps are performed. The candidate prediction is added to the initial predictor reconstructed residual 308 to obtain an estimated candidate reconstructed block. Then the distortion calculator(s) is/are applied to calculate Dj, a distortion between the encoding block and the estimated candidate reconstructed block. The rate estimator 345 is applied to MVj to obtain an estimation of the bits required for encoding this motion vector. Then the modified rate-distortion cost calculator 360 calculates the estimated RDcost_j based on the estimated rate and distortion values. The decider 370 determines which of the candidate alternate predictors is optimal and controls the output of the optimized predictor refinement module. This may be decided for example by selecting the candidate with the lowest RDcost_j value, however, other criteria or logic may also be used by the decider for this purpose. In some embodiments of the presently disclosed subject matter the encoding may proceed always using the initial predictor residual coefficients 312 combined with the selected refined motion vector. In yet other embodiments, the decider, when selecting the refined motion vector to be used, may decide, according to some internal logic, to use the coefficients corresponding to the selected motion vector. This internal logic may for example be based on the absolute difference between the initial motion vector and the selected motion vector, where the coefficients corresponding to the selected motion vector will be calculated when this difference exceeds a threshold. However, other criteria or logic may also be used by the decider for this purpose. In order to provide the coefficients corresponding to the selected motion vector, the residual between the selected predictor and encoding block is calculated by the residual calculator 325. This residual then undergoes a frequency transform and quantization by the transform and quantize module 330 and the resulting alternative residual coefficients 307 are provided as output for further encoding steps. In yet another embodiment the residual calculation and transform and quantization may be performed by corresponding blocks 126, 128 and 130 of block coding module 119.

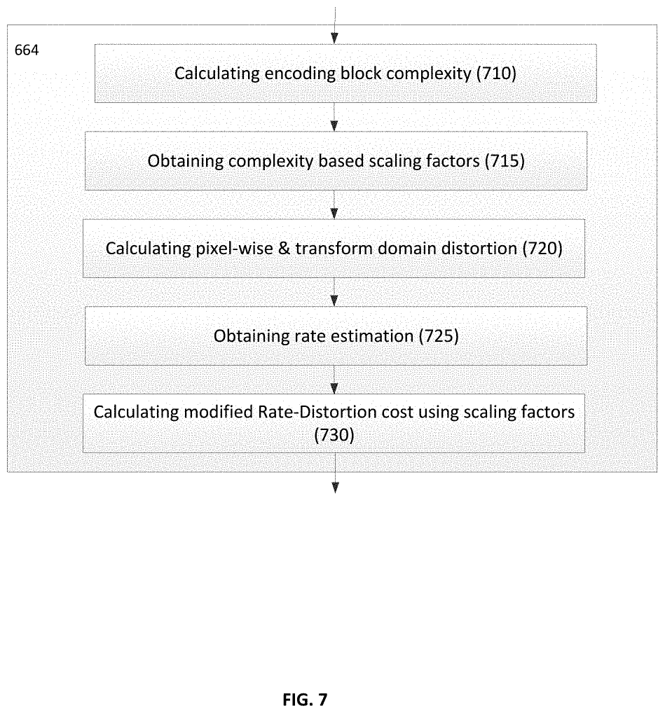

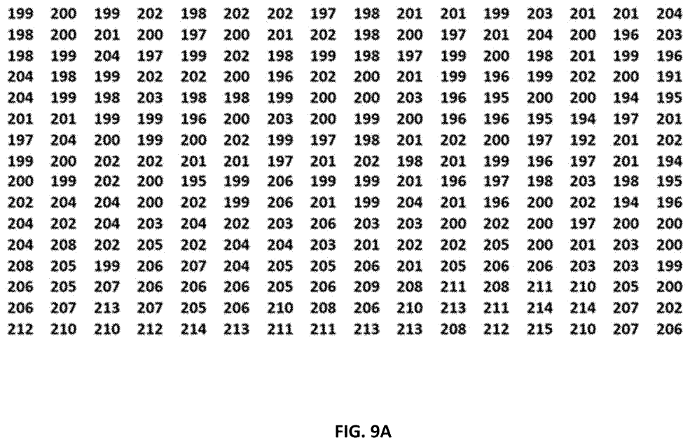

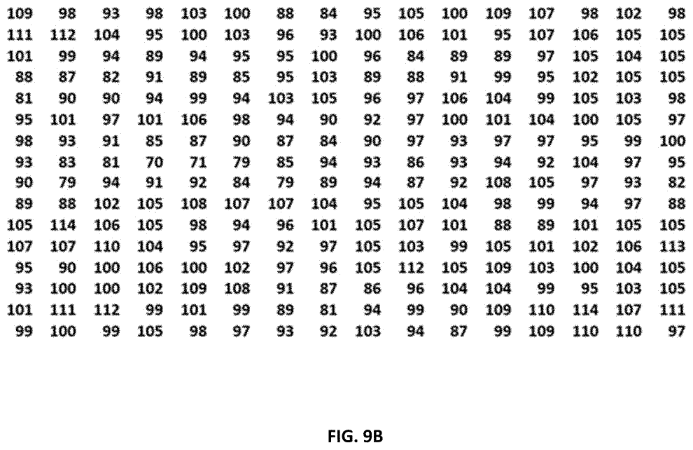

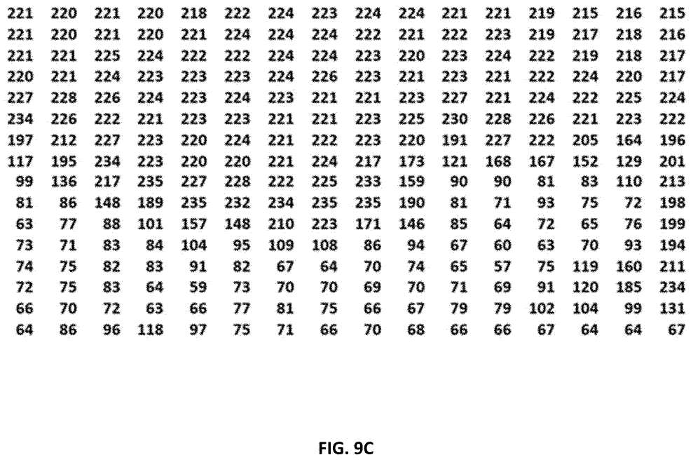

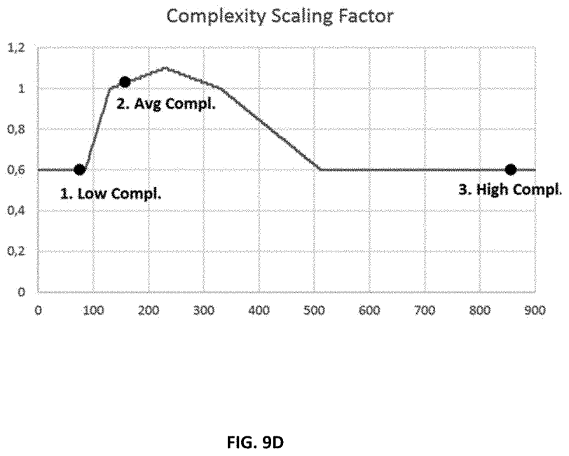

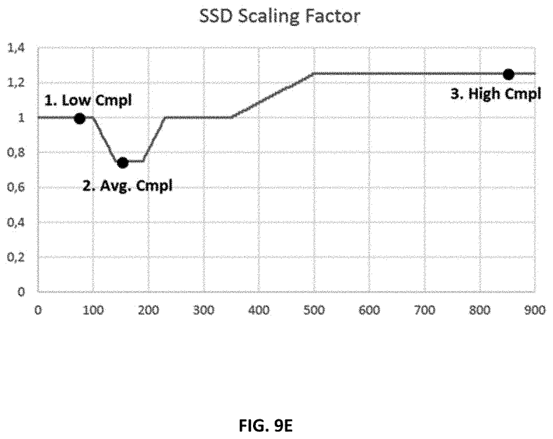

Turning now to FIG. 4, there is illustrated another block diagram of a computerized system for optimized Rate-Distortion calculation in accordance with certain embodiments of the presently disclosed subject matter. Inputs to the optimized Rate-Distortion calculator 122 are an encoding block 302, a reconstructed block 405, and the rate 407 indicating the estimated bit consumption required to encode the encoding block using data which will result in the reconstructed block 405, for example the rate associated with a corresponding motion vector and residual coefficients, this rate or bit-consumption being denoted as B. The novelty of the optimized Rate-Distortion cost calculator 122 lies in the modification of the rate distortion cost calculator according to an encoding block complexity which, in an example embodiment, may be done as follows. First, the block complexity calculator 410 is applied to the encoding block giving rise to BC the block complexity value. A non-limiting example of Block Complexity (BC) calculation could be related to the texture variation with the block. Another non-limiting example of block complexity calculation may be to perform a discrete nxn Hadamard transform on n×n sub-blocks of the encoding block, and setting BC to a value relative to the maximal sum of absolute AC Hadamard coefficients in all sub-blocks of the encoding block. The obtained BC value is then provided to the scaling factor(s) calculator 425. This calculator yields one or more scaling factors to be used in the modified rate distortion calculator 430. The scaling factors may be derived as some function of BC or from a Look-Up-Table (LUT) where a given BC value will result in a corresponding scaling factor value SCF. Further details on calculating the scaling factors(s) can be found in the description of FIG. 7 and in the numerical example presented in FIGS. 9A-9E. In some embodiments of the presently disclosed subject matter, one or more pixel domain distortion metrics between encoding block 302 and reconstructed block 405 are then calculated in the pixel-wise distortion calculator 415. This pixel distortion may be denoted as PD. Some examples of pixel-wise distortion metrics include a Peak-Signal-to-Noise-Ratio or PSNR value, a Sum of Absolute Differences or SAD, A Sum of Squared differences or SSD and a Mean Square Error or MSE. In addition, or in lieu thereof, one or more transform domain distortion metrics between encoding block 302 and reconstructed block 405 are calculated in the transform domain distortion calculator 420. This transform distortion may be denoted as TD. Examples of transform-domain distortions include sum of absolute transform coefficient differences and weighted sum of square coefficient differences, with Hadamard often used as the associated transform. In addition, for transforms typically used in video compression, some pixel domain distortion measures such as MSE, can be implemented in the transform domain using the sum of weighted square differences of the transform coefficients. The modified Rate-Distortion cost calculator then combines the calculated distortion values with the block complexity based scaling factors to calculate the modified RD cost using a formulation of the form: ModifiedRDcost=λ×B+SCF_|×PD+μ×SCF_2×TD wherein λ, μ are Lagrange multipliers, and the bitrate estimation is received from the rate estimator module 345. This modified cost is the cost 408 provided as output of the optimized Rate-Distortion calculator 122.

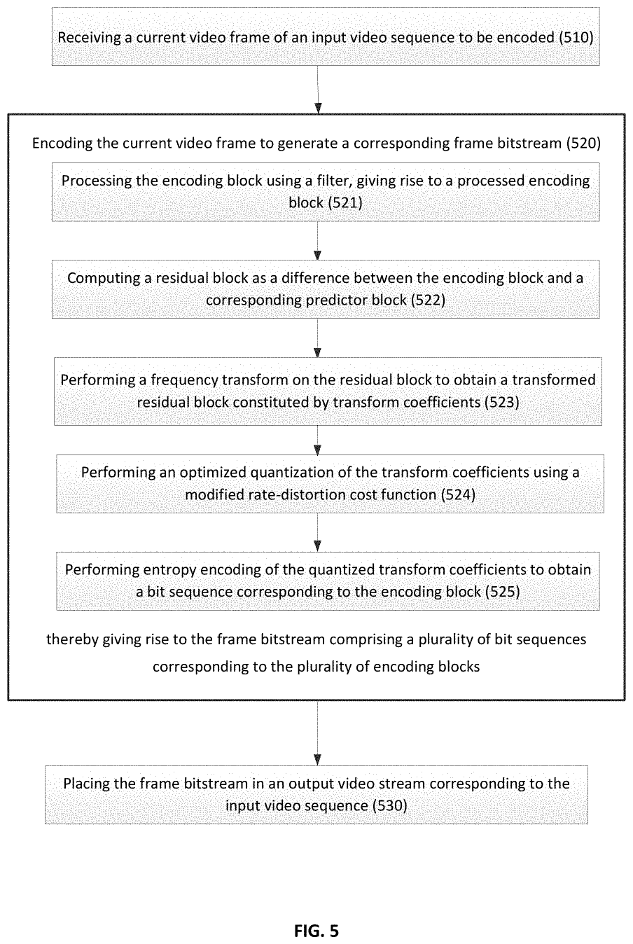

Turning now to FIG. 5, there is illustrated a generalized flowchart of optimized video encoding in accordance with certain embodiments of the presently disclosed subject matter. A current video frame of an input video sequence to be encoded can be received (510) (e.g., by the video encoding module 118 through the I/O interface 110). As aforementioned, the current video frame comprises a plurality of encoding blocks. In some cases, the current video frame can include luma and chroma pixel planes, and each pixel plane can be partitioned into one or more encoding blocks. Each encoding block is a rectangular block of pixel values from the pixel plane. In some cases, an encoding block may refer to a set of corresponding luma and chroma blocks. The current video frame can be encoded (520) (e.g., by the video encoding module 118) to generate a corresponding frame bitstream. In some embodiments, the video frame encoding can be performed in accordance with blocks 521-525. Specifically, for each encoding block of the plurality of encoding blocks, the encoding block can be processed (521) using a filter, giving rise to a processed encoding block. By way of example, the encoding block can be processed by applying a filter (e.g., a pixel domain or frequency domain filter) to the encoding block. A predictor block for the encoding block is then selected, and a residual block is computed (522) as a difference between the encoding block and the corresponding predictor block. According to certain embodiments, the predictor block can be selected from a set of candidate prediction blocks. The set of candidate prediction blocks are pixel blocks from previously encoded and reconstructed pixels belonging either to the current video frame or to a previously processed video frame in the input video sequence. The selection of the predictor block is performed so that a rate-distortion cost associated with the predictor block (also referred to as prediction rate-distortion cost) is the lowest among rate-distortion costs associated with the set of candidate prediction blocks. A frequency transform can be performed (523) on the residual block to obtain a transformed residual block constituted by transform coefficients. The frequency transform can be selected, for example, from among a set of frequency transforms supported by the compression standard being used. As known, in lossy block-based video compression methods, the key element in the bitstream representing the texture information of the encoding block is a block C represented by a set of coefficients {C(j)} corresponding to the transformed residual block, obtained as the output of step 523. An optimized quantization of the transform coefficients in this block C is performed (524) using a modified rate-distortion cost function. The quantized transform coefficient set {Cq(j)} of the quantized block Cq is compressed into a bit sequence B(Cq) corresponding to the encoding block, when entropy coding is applied on the quantized transform coefficients in step 525. Once the process in steps 521-525 is performed for all the plurality of encoding blocks, a plurality of bit sequences are generated. The bit sequences can be placed into a frame bitstream corresponding to the current video frame. The frame bitstream can be placed (530) in an output video stream corresponding to the input video sequence. In certain embodiments, the process of steps 510-530 can be repeated for encoding one or more additional video frames of the input video sequence. When all the video frames in the input video sequence are encoded, the frame bitstreams can be combined into a resulting output video stream corresponding to the input video sequence. Reconstructing the transform coefficients from the encoded video stream includes the inverse operations on the quantized block Cq. De-quantized transform coefficients can be obtained by multiplying corresponding quantized coefficients by a quantizer step size associated therewith. The inverse quantization is typically performed with:

$${C}_{R} ( j ) = sign ( {C}_{q} ( j ) ) * \frac{\vert {C}_{q} ( j ) \vert * M ( j ) + D / 2}{D}$$

resulting in the reconstructed block of transform coefficients CR. The integer numbers M(j) and D used in a given decoder are pre-defined according to the quantization level, and the integer values division is done by rounding to the nearest integer. The simplest method of quantization is a calculation of Cq(j) based on the above formula, as the inverse of the coefficients reconstruction. Such methods are called fixed dead-zone quantization and are well known in the prior art. For a specific set of quantized coefficients, the reconstruction error or distortion may be formulated as:

$$E ( {C}_{q} ) = {\sum }_{j} {E}_{j} ( {C}_{q} ( j ) , C ( j ) )$$

wherein Eⱼ(C_{q}(j), C(j)) denotes a reconstruction error corresponding to a single quantized coefficient Cq(j), relative to a corresponding initial coefficient C(j). In some embodiments, the reconstruction error can be indicative of a difference related to the transform coefficients and corresponding de-quantized transform coefficients. In more detail, the error is related to the difference between the original pixel values of the residual block corresponding to C, and the pixel values obtained when performing reconstruction of the pixels by inverse quantization and inverse transform applied to Cq. Based on this, the problem of optimal quantization in the encoder can be formulated: obtain the quantized coefficients Cq which meet the contradictory requirements of minimizing both the number of compressed bits B(Cq) and the block reconstruction error E(Cqr, C).

In a Rate-Distortion optimized quantization method the quantized coefficients Cq are calculated as a minimization problem solving: C_{q}=argmin(E(C_{q}, C)+λB(C_{q})), wherein the Lagrange multiplier λ is pre-defined for a given block and quantization level. In practice, trellis quantization algorithms are usually used for an efficient numeric solution of this minimization problem.

Although the quantization methods that are based on Rate-Distortion provide the encoding close to optimal in the Rate-Distortion sense, their usage typically leads to smoother reconstructed images compared to those provided by simple fixed dead-zone quantization. This in turn results in lower perceived visual quality of the reconstructed video. The present disclosure proposes an optimized quantization of the transformed residual block of transform coefficients using modified reconstruction errors in Rate-Distortion cost functions which utilize a function related to the encoding block and the processed encoding block. The optimized quantization as illustrated in step 524 and described below is targeted at maintaining the advantages of Rate-Distortion based quantization while simultaneously improving the perceived visual quality of the reconstructed video. Specifically, upon decoding the output video stream, a reconstructed video frame corresponding to the current video frame has optimized perceived visual quality as compared to perceived visual quality of a reconstructed video frame of a corresponding frame bitstream which is generated without using the optimized quantization.

According to some embodiments, the encoding block can be processed by applying a filter in the pixel domain to the encoding block. A frequency transform can be performed on the encoding block to obtain a transformed encoding block, and can be performed on the processed encoding block to obtain a transformed processed encoding block, as illustrated in FIG. 2. The function used to configure the reconstruction error (as calculated in the modification module 228) can be based on a relation between the transformed encoding block and the transformed processed encoding block.

According to some other embodiments, a frequency transform can be first performed on the encoding block to obtain a transformed encoding block. A filter in the transform domain can be applied to the transformed encoding block to obtain the transformed processed encoding block, as illustrated in FIG. 2B. The function used to configure the reconstruction error (as calculated in the modification module 228) can be based on a relation between the transformed encoding block and the transformed processed encoding block.

For purpose of illustration and exemplification, the initial encoding block pixels are denoted as pixels P_{orig} and Pₛₕₐᵣₚ. The encoding block is processed in step 521, for example, by applying a filter (e.g., a texture sharpening filter) on the initial block. Denote the transform coefficients of a frequency transform of the blocks P_{orig} and Pₛₕₐᵣₚ as T_{orig} and Tₛₕₐᵣₚ correspondingly. Alternatively, in another embodiment, T_{orig} is obtained in the same manner while Tₛₕₐᵣₚ is obtained by applying a transform domain filter to T_{orig}. The relation associated with the encoding block and processed encoding block, which is used to configure the reconstruction error, can be, in some cases, a relation between corresponding pixel values in the two blocks P_{orig} and Pₛₕₐᵣₚ. In some other cases, the relation can be between corresponding transform coefficients of the transformed encoding block T_{orig} and the transformed processed encoding block Tₛₕₐᵣₚ. For instance, consider the block T_{scale} whose elements can be calculated for example as T_{scale}(j)=Tₛₕₐᵣₚ(j)−T_{orig}(j), or in yet another example as T_{scale}(j)=Tₛₕₐᵣₚ(j)/T_{orig}(j) or via any other suitable relations thereof. Then, in one embodiment of the presently disclosed subject matter, it is proposed to calculate the quantized transform coefficients for the fixed quantization level as:

$${C}_{q} = argmin ( λ \cdot B ( {C}_{q} ) + {\sum }_{j} {X}_{j} ( {T}_{sharp} ( j ) , {T}_{orig} ( j ) ) \cdot {E}_{j} ( {C}_{q} ( j ) , C ( j ) + {Y}_{j} ( {T}_{sharp} ( j ) , {T}_{orig} ( j ) ) )$$

wherein functions Xj and Yj are parameters of the modification method. In some embodiments, the reconstruction error Ej can be configured by scaling the reconstruction error by a scaling factor (Xj) which is dependent on the relation. In some embodiments, the reconstruction error Ej can be configured by adding to the reconstruction error a difference value (Yj). For instance, a difference between transform coefficients in the transformed encoding block and the corresponding transformed processed encoding block can be calculated, and the difference can be clipped in accordance with a quantizer step size to obtain the difference value. Note that adding the function Yⱼ(Tₛₕₐᵣₚ(j)T_{orig}(j)) to the initial coefficients C(j) as done here is equivalent to adding it to the difference C(j)−C_{R}(j) in the square error calculation. Examples of functions Xj and Yj include but are not limited to setting Xj to 1, and Yⱼ(x, y)=clip(2(x−y),−D/(2M(j))), wherein clip(x, A, B) means clipping the value x in range [A; B]. In another example Xj is set to be some monotonically non-decreasing function and Yj is set to zero. The solution to this minimization problem can then be found using the same methods employed in conventional Rate-Distortion optimizing of quantization such as the Trellis scheme, the RDOQ approach implemented in the HM16 test model, etc.

As aforementioned, in some embodiments the processing of the encoding block may be implemented using a sharpening filter which is usable for enhancing one or more features in the encoding block including, e.g., edges, etc. By way of a non-limiting example the sharpening filter may be implemented as:

$${P}_{sharp} ( j ) = ( 16 \cdot {P}_{orig} ( j ) - {\sum }_{k ∈ {N}_{8} ( j )} {P}_{orig} ( k ) ) / 8$$

wherein N_{B}(j) is the indices set for 8 pixels spatially neighboring to P_{orig}(j).
In yet other embodiments the processing of the encoding block may be applied multiplicatively in the transform coefficients domain as Tₛₕₐᵣₚ(j)=α(j)·T_{orig}(j). In this case is possible to set T_{scale}(j)=α(j). Note that if the transform used by the video coding algorithm keeps the convolution-multiplication property and a linear FIR filter is used for processing in the pixel domain, then there exists an equivalent multiplication filter in the transform domain which may be used instead.

It is to be noted that the optimized encoding as described above with reference to FIG. 5 can be used for image encoding as well, in which cases the current video frame is a single input image. For instance, an encoding block of the image can be processed using a filter. A frequency transform can be performed on the encoding block. An optimized quantization can be performed on the transform coefficients of the transformed encoding block using a modified rate-distortion cost function, giving rise to quantized transform coefficients. Similarly, the modified rate-distortion cost function can be obtained by configuring a reconstruction error in a rate-distortion cost function in accordance with a relation associated with the encoding block and the processed encoding block. Entropy encoding can be performed on the quantized transform coefficients to obtain a bit sequence corresponding to the encoding block, thereby giving rise to image bitstream comprising a plurality of bit sequences corresponding to the plurality of encoding blocks. In such ways, a reconstructed image corresponding to the image bitstream has optimized perceived visual quality as compared to perceived visual quality of a reconstructed image of a corresponding image bitstream which is generated without using the optimized quantization.

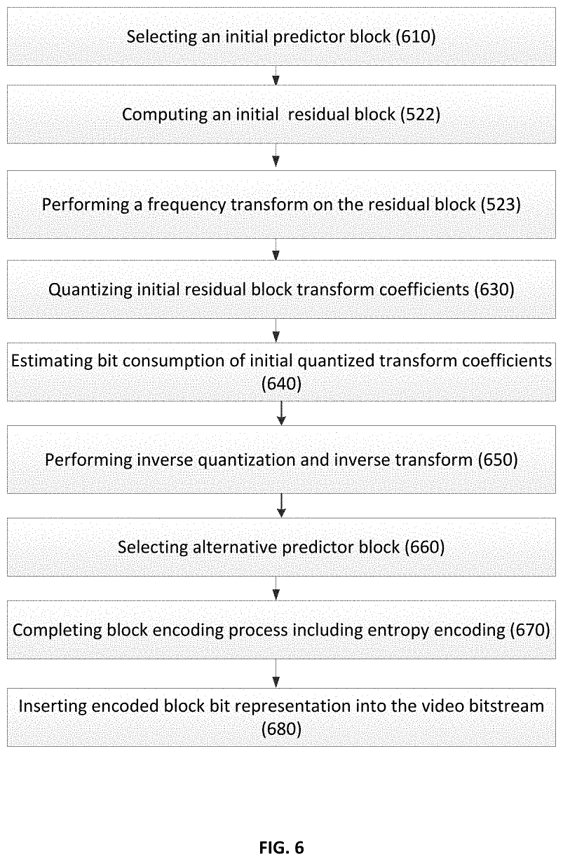

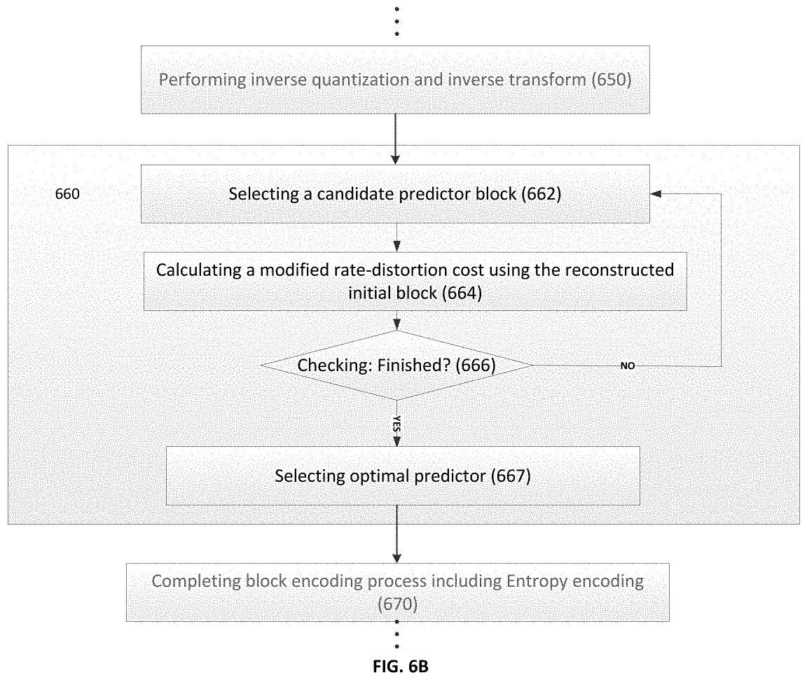

Turning now to FIG. 6, there is illustrated a generalized flowchart of a computerized system for optimized motion vector refinement in accordance with certain embodiments of the presently disclosed subject matter. As aforementioned, and as known to those skilled in the art of video compression, hybrid block-based video compression techniques perform partitioning into encoding blocks in single or multiple stages. Then for each encoding block, some or all of the following steps presented in FIG. 6 are generally performed:

An initial prediction pixels block P_{pred} is obtained for the current pixel block P, as depicted in step 610.

In step 522 pixels of an initial prediction residual block are calculated as Rᵢₙᵢₜ(j)=P_{orig}(j)−P_{pred}(j), wherein (j) indexing denotes individual pixels of the blocks.

A frequency transform, such as an integer approximation of the Discrete Cosine Transform, is applied to Rᵢₙᵢₜ resulting in the transform coefficients block C, as depicted in step 523.

Transform coefficients block C is quantized resulting in the quantized coefficients block C_{q}, as depicted in step 630.

In step 640 the block of quantized coefficients is either compressed using full entropy decoding resulting in a bit sequence consisting of B(Cq) bits, or alternatively B(Cq) is set to an estimate of the bits requires to encode the block of quantized coefficients foregoing the entropy encoding at this stage in order to reduce computational costs. The number of bits corresponding to the header data of the block, denoted as B_{header} and corresponding for example to the prediction mode or Motion Vector used, is similarly either calculated or estimated.

The quantized coefficients block C_{q} is inverse quantized resulting in the block of the reconstructed coefficients C_{rec}, and the reconstructed coefficients block C_{rec} is inverse transformed resulting in the reconstructed prediction residual block R_{rec}, as depicted in step 650.
A reconstructed pixel block P_{rec} is calculated pixelwise as P_{rec}(j)=P_{pred}(j)+R_{rec}(j).

Further details on this system, previously described in regard to FIG. 3, will now be provided. This disclosure will be limited to an encoding block encoded using INTER prediction, i.e. the block predictor block being obtained from a previously encoded and reconstructed video frame. Without limitation, the block is associated with coordinates (X, Y) n in the current video frame or pixel plane. The initial prediction pixels block P_{pred} selected or obtained in step 610 is a pixel block of the same size as the encoding block with coordinates (X+MVₓ, Y+MV_{y}) from some previously coded reference frame. In the most conventional video coding algorithms the components MVₓ, MV_{y} may have fractional parts. In this case the prediction pixel values are interpolated for non-integer coordinates using pre-defined interpolation filters. The two-dimensional vector MV=(MVₓ, MV_{y}) is called the Motion Vector or MV for the given current block and given a specific reference frame it clearly defines the prediction block. The MV components are encoded into the coded video stream as a part of the block header in step 670, and their bit-consumption is calculated or estimated by the rate estimator 345. Numerous motion estimation methods providing different speed/quality trade-offs finding motion vectors exist in prior art. Almost all of them operate by minimizing a Rate-Distortion cost function incorporating the (estimated) bit consumption and some measure of the distortion is introduced when encoding with the proposed MV. It is worth noting that the decoding process of motion compensation, or creating the predictor and reconstructed block given an MV and residual, is generally standardized. However, as known to those versed in the art, the algorithm used to seek an optimized selection of the MV is not, and often may be responsible for, much of the encoder computational load. As motion estimation algorithms include a significant number of cost function calculation for different values of candidate MVs, it is common practice to use very simple bitrate and distortion estimators when calculating the per candidate MV RD cost. For example metrics often used to measure distortion are a Sum of Absolute pixel Difference (SAD) between P_{orig} and P_{pred}, or a Sum of P_{orig} and P_{pred} Absolute Hadamard transform coefficients Differences (SAHD), or a Sum of P_{orig} and P_{pred} pixels Square Differences (SSD).

Thus, for example, when SSD is selected as the distortion metric to be used, Rate-Distortion optimized encoding will select encoding parameters for each inter block in order to minimize the block cost function of the form:

RDcost=λ×(B(Cq)+B_{header})+SSD(P_{orig}, P_{rec}) wherein λ is a pre-defined Lagrange multiplier and SSD(P_{orig}, P_{rec}) is a sum of square differences between the pixel blocks P_{orig} and P_{rec}. This cost function calculation is very computationally costly since it requires fulfilling all of the steps presented above of calculating a residual, transforming, quantizing, entropy coding for bit estimation, inverse quantizing, inverse transforming and calculating the reconstructed block P_{rec}. Note that for a given reference frame and a given encoding block the blocks, P_{pred}, P_{rec}, R_{rec}, Cq, the value of B_{header} and the cost function RDcost are fully defined by the motion vector MV used for inter-prediction. This is why they may be referred to as P_{pred}(MV), P_{rec}(MV) etc.

For the purpose of cost function minimization, the motion estimation is sometimes done in two stages. The first stage includes selecting a primary motion estimation resulting in the motion vector MVo. At the second stage, additional Rate-Distortion optimizing refinement of the motion vector MVo is performed, with the goal of seeking an optimal MV from a set of candidates “similar” to MVo for example in the spatial vicinity of MVo. The optimal motion vector is the one corresponding to the lowest value of RDcost, and it will be used to complete the block encoding as depicted in steps 670 and 680. Note this is particularly prevalent when reusing motion information obtained using corresponding lower resolution content, which for example may be performed in a pre-process step, or in cascade or hierarchical video encoding, or in multi-stream encoding when multiple resolutions are encoded simultaneously. It is also often used in the context of sub-pixel MV refinement, where the initial search seeks the best full-pel or integer pixel MV and the refinement stage finds the sub-pel offset providing the best prediction result.

This additional Rate-Distortion optimizing motion vector refinement at the second stage increases the encoding quality in Rate-Distortion sense but leads to a dramatic slow-down of the encoding, or increase in computational requirements, and thus cannot be used when encoding speed, or when CPU utilization is a primary concern.

The proposed optimized method for selecting an alternative predictor block, depicted in step 660, offers a solution which is both significantly faster than the simple one described above, and at the same time yields predictors which are almost as optimal, thus significantly improving coding efficiency compared to the case of using the initial MV, without further refinement, to encode the block.

In accordance with certain embodiments of the optimized motion vector refinement presently disclosed, it is proposed to use the prediction residual corresponding to the initial motion vector when evaluating the corresponding RDcost for all alternative MV candidates, thus not requiring performing the computationally costly steps 522, 523, 630, 640 and 650 per each candidate MV. In some embodiments, the initial residual may be used for encoding the bitstream. In other embodiments, steps 522, 523, 630, 640 and 650 may be repeated for the selected MV only, still obtaining significant performance improvement as they are not performed per each MV candidate. In yet other embodiments, the optimized refinement may be applied as an iterative process, whereby, after selection of the optimized predictor, this MV is considered the ‘new’ MVo and the refinement process is repeated.

Some further details are now provided describing an example embodiment of step 660, as depicted in FIG. 6B. The input parameters to step 660 are the encoding block, or current original pixel block P_{orig}, the initial motion vector MVo and the prediction area from which the predictor is to be selected. The output of step 660 is the resulting motion vector MVₒₚₜ and the blocks C_{q}^{opt} and R_{rec}^{opt} for the block encoding. In addition, since preceding steps have been performed, blocks P_{pred}(MV₀), R_{rec}(MV₀), P_{rec}(MV₀), C_{q}(MV₀) are obtained and the values of B(C_{q}(MV₀)), B_{header}(MV₀). Thus, the RdCost associated with MVo is calculated as:

RdCost(MV₀)=λ·(B(C_{q}(MV₀))+B_{header}(MV₀))+SSD(P_{orig},P_{rec}(MV₀)

In Step 662 a candidate motion vector is selected, and the full set of candidates selected can be defined as MVⱼ, j∈1̅,̅ N̅. Then in step 664 the values of RdCost (MVⱼ) can be calculated as:

RdCost(MVⱼ)=λ·(B(C_{q}(MV₀))+B_{header}(MVⱼ))+SSD(P_{orig},P_{pred}(MVⱼ)+R_{Rec}(MV₀))

This process is repeated for each candidate MV until step 666 determines that all candidates have been evaluated. Then, in 667 the optimized motion vector MVₒₚₜ is selected, as the MVⱼ corresponding to the minimal value of RdCost(MVⱼ), j∈0̅,̅ N̅, and the following is performed:
Assign C_{q}^{opt}=C_{q}(MV₀), R_{rec}^{opt}=R_{rec}(MV₀).
Optionally, if MV₀≠MVₒₚₜ perform steps 522, 523, 630, 640 and 650 for the motion vector MVₒₚₜ and assign C_{q}^{opt}=C_{q}(MVₒₚₜ), R_{rec}^{opt}=R_{rec}(MVₒₚₜ).
Optionally, if MV₀≠MVₒₚₜ then assign MV₀=MVₒₚₜ and repeat the algorithm.

The functions used above in RDcost calculation are provided as a non-limiting example only. The proposed optimized refinement may be used in conjunction with any other distortion functions.

Turning now to FIG. 7, there is illustrated a generalized flowchart of a computerized system for complexity based Rate-Distortion estimation in accordance with certain embodiments of the presently disclosed subject matter. More specifically, the system is designed to use complexity dependent weighting factors when calculating Rate-Distortion costs.

For this figure it is assumed that an encoding block is obtained, as described with reference to previous figures. Optionally, processing of the encoding block, as described regarding FIG. 5, is then applied. In hybrid block-based video compression each encoding block may be coded in one of several coding modes. The supported modes are defined in a corresponding video encoder standard or specification, and may include various intra prediction and inter prediction modes. Determining the optimal mode for each encoding block is entirely at the discretion of the encoder implementation. Thus, for each encoding block, the encoder aims to select a coding mode which provides a good trade-off between the quality of the reconstructed block texture and the block rate, that is the number of bits corresponding to the block in coded video stream. For this purpose, a mode Rate-Distortion (RD) cost is calculated in the encoder for each available coding mode, and the mode providing the minimal cost is selected. The output of the flow chart in this figure is the predictor selection and will be described in greater detail forthwith. Having selected the block encoding mode and corresponding predictor, the residual block can be computed as illustrated in step 522 of FIG. 5 and the encoding continues as described for example in reference to FIG. 5.

Step 664 illustrates an example of mode selection in accordance with certain embodiments of the presently disclosed subject matter. First, the complexity of the encoding block is calculated in step 710. This complexity may be calculated based on the pixels themselves or some transform thereof. The calculated Block Complexity may be denoted as BC. This block complexity may for example be a measure of the texture, or texture strength, variation in the block.

In one non-limiting example, BC may be calculated as follows: Denote Bⱼ^{8×8}, j∈1̅,̅ N̅−a set of 8×8 sub-blocks constituting the encoding block B and HAC_{8×8}(Bⱼ^{8×8})—a sum of absolute values of AC coefficients of Bⱼ^{8×8} discrete Hadamard transform. Then, the block complexity may be calculated as:

$$BC = \frac{1}{5} \cdot {max}_{j ∈ 1 … N} {HAC}_{8 \times 8} ( {B}_{j}^{8 \times 8} )$$

Next, in step 715, the calculated complexity value BC is used to obtain corresponding one or more scale Factor values, denoted below as F. This may be done via a calculation, a Look-Up-Table or using any mapping function. For example, and without limitation, a single scale Factor value F(BC) may be used, which will be used to scale a distortion metric in the RD cost calculation, according to block complexity. In a further example two scale Factor values may be used, each to scale a different distortion metric in the RD cost calculation. In yet another example, the possible range for BC values may be divided into N intervals, interval_1 corresponding to very low complexity values, and interval_N corresponding to very high complexity levels, and different scale Factor values or scale Factor functions may be used for the different intervals. Further by way of example, there may be four Scale-Factor values: A pair of scaling factors, one for high and one for low levels of BC, used to scale a texture complexity difference based distortion metric: F_{cmpl}^{low}(BC) and F_{cmpl}^{high}(BC), and another pair of scaling factors, again one for high and one for low levels of BC, used to scale a Sum of Square Differences based distortion metric: F_{ssd}^{low}(BC) and F_{ssd}^{high}(BC). These scale factors will be used in calculating the modified RD cost as detailed below. In a non-limiting example of a possible calculation of these scaling factors according to BC, the possible range for BC values is divided into 6 intervals, where interval_1 corresponds to BC values from 0 to interval_2_s (non-inclusive), interval_2 corresponds to BC values from interval_2_s to interval_3_s (non-inclusive) etc. Then, the scaling Factor, can be calculated for the low complexity intervals 1-3 as a monotonically non-decreasing function of the form:

$${F}^{low} ( BC ) = \{ \begin{matrix}C 1 , & if BC ∈ interval\_ 1 \\ C 1 + ( BC - interval\_ 2 \_s ) \cdot R 1 , & if BC ∈ interval\_ 2 \\ C 2 + ( BC - interval\_ 3 \_s ) \cdot R 2 , & if BC ∈ interval\_ 3\end{matrix}$$

And the scaling Factor for the high complexity intervals 4-6, can be calculated as a monotonically non-increasing function of the form:

$${F}^{high} ( BC ) = \{ \begin{matrix}C 3 - ( BC - {interval}_{{4}_{s}} ) \cdot R 4 , & if BC ∈ interval\_ 4 \\ C 4 - ( BC - {interval}_{{5}_{s}} ) \cdot R 5 , & if BC ∈ interval\_ 5 \\ C 4 , & if BC ∈ interval\_ 6\end{matrix}$$

whereby C1, C2, C3, C4 and R1, R2, R4, R5 are constant and ratio values selected such that the value corresponding to the highest BC value of interval_i equals the value corresponding to the lowest BC value of interval_i+1. These function forms and division into 6 intervals is provided by way only of a non-limiting example. In yet another example, the scaling factors may be calculated using a monotonically non-increasing function for low complexity intervals, and a monotonically non-decreasing function for the high complexity intervals.

Steps 720, 725 and 730 are then repeated for each candidate encoding mode, with the goal of finding the optimal mode to use when encoding the block. In step 720 selected distortion measures are calculated for the encoding block and a reconstructed block associated with the candidate mode, wherein the reconstructed block may be received for example using the decoding/reconstruction module 134 possibly after employing one or more of blocks 126, 128 and 130 to calculate a residual, and perform frequency transform and quantization. These distortion measures may be calculated using block 350, block 415 and/or block 420 previously described. A bitrate or rate estimate associated with encoding the block with the candidate mode is obtained in step 725, for example using block 345. Then, in step 730 the modified rate-distortion cost is calculated using the distortion(s) calculated in step 720, the rate estimate form step 725 and the scaling factors obtained in step 715. For example, as is implemented in some existing video encoding implementations, the RD cost may be calculated as:

Cost=SSD(B_{orig}, B_{rec})+λ·R+μ·CmplDiff(B_{orig}, B_{rec}), wherein R is the a block rate, SSD(B_{orig}, B_{rec}) is a sum of square differences between the original encoding block B_{orig} pixels, and the reconstructed block B_{rec} pixels, CmplDiff(B_{orig}, B_{rec}) is a measure of difference between the texture variation strengths of the original B_{orig} and the reconstructed B_{rec} blocks, and λ, are pre-calculated constants depending on the quantization level.

In Rate-Distortion optimized encoding, driven purely by the numeric distortion and rate values, μ is usually set to zero. Non-zero values of μ are used in order to improve the subjective quality of the reconstructed frame. Using non-zero μ values enables better preserving the accuracy of perceived fine texture elements in the frame. Typically, as μ increases, the size or bitrate of the block corresponding to the optimal coding mode will also increase. Thus, an increase of μ causes the RD optimization process to converge to selections which result in increase of the frame visual or subjective quality, at the price of an increase in the bitrate. Thus, an optimal value of μ for a given quantization level will provide the optimal perceptual quality/rate relation or trade-off.

Thus, adapting the Lagrange multipliers λ and μ in a content adaptive manner, in particular, according to the encoding block complexity, and not only according to quantization level as done in some existing video encoding implementations, can lead to better encoding decisions and thus allow for better subjective quality of video at a specific bitrate when compared to a result obtained with a video encoder which does not employ this adaptation.

While investigating adaptation of μ it became apparent that while usage of “large” values of μ were beneficial for perceptual quality obtained when encoding blocks with “average” complexity, they were not beneficial for blocks with smooth texture and low complexity. Furthermore, when encoding highly contrasting blocks with very strong texture variations, or high complexity, sufficient quality and texture preservation was achieved even without using “large” values of μ. Thus, uniformly using large value of μ for all encoding blocks, while improving visual quality for some blocks, will also introduce a rate increase in other blocks without corresponding increase in obtained visual quality. Hence, it is proposed to apply the scaling factors described above in reference to step 715, calculating the RD cost as:

Cost=λ·R+F_{ssd}(BC)·SSD(B_{orig},B_{rec})+F_{cmpl}(BC)·μ·CmplDiff(B_{orig},B_{rec})

wherein F_{ssd}(BC) and F_{cmpl}(BC) are scaling factors dependent on the encoding block complexity BC, and wherein different functions or LUTs may be used to implement each of these scaling factors.

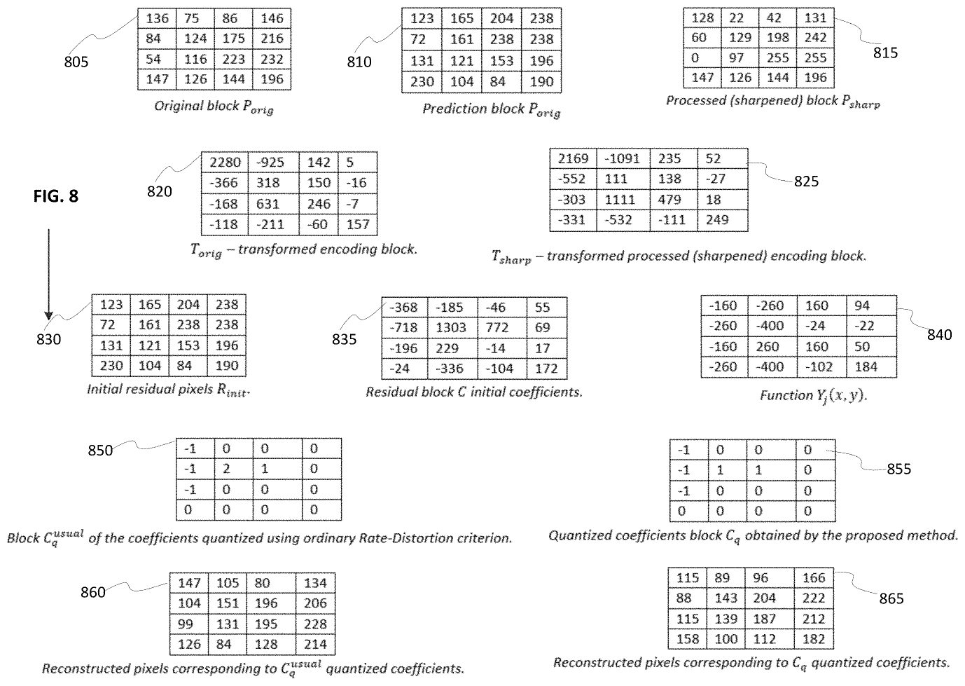

Turning now to FIG. 8, there is illustrated an example of optimized quantization computations performed in accordance with certain embodiments of the present invention. The purpose of this example is to show, for the purpose of clarity, one instance of employing a certain embodiment of the proposed subject matter on an actual example 4×4 encoding block, and by no means intends to limit the proposed subject matter by any of the details set forth in this numerical example.

In 805 P_{orig} is presented, the 4×4 encoding block used for the duration of this example. The numerical values correspond to the 8-bit pixel values of the block. This corresponds also to input 202 of FIG. 2.

The pixel values of the selected prediction block, P_{pred}, are presented in 810. This is another 4×4 8-bit pixel value set, taken from a previously reconstructed block in the encoded video stream.

In this example, the processing of the encoding block is performed in the pixel domain, corresponding to block 224. The processing involves applying a sharpening filter, resulting in the processed block Pₛₕₐᵣₚ, depicted in 815. In the example this block is obtained from P_{orig} by applying a sharpening filter of the form:

$${P}_{sharp} ( j ) = ( 16 \cdot {P}_{orig} ( j ) - {\sum }_{k ∈ {N}_{8} ( j )} {P}_{orig} ( k ) ) / 8$$

where N₈(j) is the indices set for 8 pixels spatially neighboring to P_{orig}(j)), followed by a clipping operation to limit the values to the 8-bit range [0, 255]. Then, the frequency transform used in the encoding process is applied to each P_{orig} and Pₛₕₐᵣₚ, corresponding to block 226, and yielding transform coefficients blocks T_{orig} depicted in 820 and Tₛₕₐᵣₚ depicted in 825. Note that in this example the transform and quantization procedures are performed in accordance with those of the H.264 or AVC video coding standard.

The 4×4 residual block Rᵢₙᵢₜ, corresponding to 202, also supplied to the optimized quantization module as input, is depicted in 830. The frequency transform used for encoding is applied resulting in a block of initial coefficients C, depicted in 835.

Using a Quantization Parameter (QP) value equal to 42 and the de-quantization procedure as indicated in H.264 video coding standard, the quantized coefficients block C_{q}^{usual} depicted in 850 would be obtained when applying the “usual”, non-novel Rate-Distortion optimized quantization with a simplified Trellis scheme to the residual block Rᵢₙᵢₜ.

However, using the proposed method, the minimization problem for the quantized coefficients calculation is modified as

$${C}_{q} = argmin ( λ \cdot B ( {C}_{q} ) + {\sum }_{j} {X}_{j} ( {T}_{sharp} ( j ) , {T}_{orig} ( j ) ) \cdot {E}_{j} ( {C}_{q} ( j ) , C ( j ) + {Y}_{j} ( {T}_{sharp} ( j ) , {T}_{orig} ( j ) ) )$$

where, in the scope of this example set Xⱼ(x, y)≡1 is set, and Yⱼ(x, y)=clip(2(x−y),−D/(2M (j)), D/(2M(j))), wherein clip(x, A, B) means clipping the value x in range [A; B]. The function Yⱼ(x, y) for this example is depicted in 840.

Applying the proposed quantization method using a QP value of 42 will result in the quantized coefficient block C_{q} depicted in 855. As seen in this example, the only difference between C_{q}^{usual} and C_{q}, is the value of the coefficient at the position (1,1): due to different signs of Yⱼ and C at this position the optimal absolute value of the corresponding quantized coefficient for the proposed method appears to be lower than that for the ordinary Rate-Distortion based method.

In order to understand the impact of this difference, the resulting reconstructed block corresponding to C_{q}^{usual} is also provided, depicted in 860, and reconstructed block corresponding to C_{q}, depicted in 865. As expected, the Sum of Square Differences (SSD) between the encoding block and the reconstructed block is lower for the case of ordinary RD-based quantization (8,706 vs 10,354). However, the SSD between the reconstructed block and the processed or sharpened encoded block is lower for the proposed method: 33,729 vs 3,5393.

Thus, in this example, the proposed method provides a reconstructed block which is both closer to the sharpened encoded block, thus introducing less smoothing or texture loss visual artifacts in the reconstructed video, while simultaneously reducing the bit rate or number of bits required to encode the block due to the lower absolute value of the (1,1) coefficient.

Turning now to FIG. 9A-9E there is illustrated a numerical example of blocks of varying complexity and their corresponding scale factors in accordance with certain embodiments of the presently disclosed subject matter. Note that this is provided only as one specific example, for the purpose of clarity, and is not intended in any way to limit the scope of the invention.

In FIGS. 9A-9C three examples of a 16×16 pixel areas or blocks, with varying levels of block complexity, are presented. In this numerical example the BC metric is employed, presented in paragraph [0084], and separate scaling factors to scale each of the SSD distortion metric and the complexity distortion metric, as described in paragraph [0088].

FIGS. 9D and 9E present the scaling factor functions used in this example. Specifically, the intervals and constants used for the scaling factor functions in this example are as follows:

$${F}_{cmpl}^{low} ( BC ) = \{ \begin{matrix}0.6 , if BC ∈ [ 0 , 85 ) \\ 0.6 + ( BC - 85 ) \cdot 0.4 / 45 , if BC ∈ [ 85 , 130 ) \\ 1 + ( BC - 130 ) \cdot 0.1 / 100 , if BC ∈ [ 130 , 230 )\end{matrix} \\ {F}_{cmpl}^{high} ( BC ) = \{ \begin{matrix}1.1 - ( BC - 230 ) \cdot 0.1 / 100 , if BC ∈ [ 230 , 330 ) \\ 1 - ( BC - 330 ) \cdot 0.4 / 182 , if BC ∈ [ 330 , 512 ) \\ 0.6 , if BC > 512\end{matrix} \\ {F}_{ssd}^{low} ( BC ) = \{ \begin{matrix}1 , if BC ∈ [ 0 , 100 ) \\ 1 - ( BC - 100 ) \cdot 0.25 / 40 , if BC ∈ [ 100 , 140 ) \\ 0.75 , if BC ∈ [ 140 , 190 )\end{matrix} \\ {F}_{ssd}^{high} ( BC ) = \{ \begin{matrix}0.75 + ( BC - 190 ) \cdot 0.25 / 40 , if BC ∈ [ 190 , 230 ) \\ 1 , if BC ∈ [ 230 , 350 ) \\ 1 + ( BC - 350 ) \cdot 0.25 / 150 , if BC ∈ [ 350 , 500 ) \\ 1.25 , if BC > 500\end{matrix}$$

In addition, two constants A_{cmpl} and A_{ssd} are defined, which, for the sake of this example, are set to 230 and 190 respectively, and, accordingly, scaling factors are set to:

$${F}_{cmpl} ( BC ) = \{ \begin{matrix}{F}_{cmpl}^{low} ( BC ) , if BC \leq {A}_{cmpl} \\ {F}_{cmpl}^{high} ( BC ) , if BC > {A}_{cmpl}\end{matrix} \\ {F}_{ssd} ( BC ) = \{ \begin{matrix}{F}_{ssd}^{low} ( BC ) , if BC \leq {A}_{ssd} \\ {F}_{ssd}^{high} ( BC ) , if BC > {A}_{ssd}\end{matrix}$$

These scaling factors are incorporated into the RD cost as described above to obtain:

Cost=λ·R+F_{ssd}(BC)·SSD(B_{orig},B_{rec})+F_{cmpl}(BC)·μ·CmplDiff(B_{orig},B_{rec})

FIG. 9A depicts a block corresponding to an image of a cloud which is quite smooth, with some low-level noise. This is an example of a low complexity block. For example, when using the BC metric presented in paragraph [0084], for this block the values of HAC_{8×8}(Bⱼ^{8×8}), j=1 . . . 4 are 192, 276, 295, 386. Thus, the block complexity value calculated as BC=⅕·max_{j∈1 . . . N} HAC_{8×8}(Bⱼ^{8×8}) equals 77. Using the above example scaling factor formulations, F_{ssd}(77)=1 are obtained, and F_{cmpl}(77)=0.6, as is illustrated in point #1 on the graphs in FIGS. 9D and 9E. As there is no need to concentrate on fine texture details preservation in smooth block encoding, the complexity scaling factor in this case is reduced.

FIG. 9B depicts a block corresponding to an image of grass which has delicate, visually significant, texture. This is an example of a mid-level complexity block. When employing the same metrics for this block as for the previous one, values of HAC_{8×8}, j=1 . . . 4 are 755, 523, 743, 750, thus block complexity value calculated as

$$BC = \frac{1}{5} \cdot {max}_{j ∈ 1 … N} {HAC}_{8 \times 8} ( {B}_{j}^{8 \times 8} )$$

equals 151. Using the above example scaling factor formulations, F_{ssd} (151)=0.75 are obtained, and F_{cmpl}(151)=1.02, as is illustrated in point #2 on the graphs in FIGS. 9D and 9E. For this type of block, preservation of texture details is more important for subjective quality of the reconstructed video, than preserving the pixel-by-pixel accuracy. Hence the weight of the SSD component is lower, and complexity component is given more weight in the RD cost calculation.

FIG. 9C depicts a block corresponding to a boundary area between a tree and the bright sky in the background. This is an example of a high complexity block. Again, employing the same metrics for this block, values of HAC_{8×8}(Bⱼ^{8×8}), j=1 . . . 4 are 1652, 1925, 4054, 4284; thus, the block complexity value equals 856. The corresponding scaling factors using the above example scaling factor formulations are F_{ssd}(151)=1.25, and F_{cmpl} (151)=0.6, as is illustrated in point #3 on the graphs in FIGS. 9D and 9E. Generally, for blocks with very sharp details and high contrast boundaries, providing high pixel-by-pixel accuracy provides good subjective quality of the reconstructed image. Thus, by using a low scaling factor for the texture or complexity distortion component, both lower bitrate when encoding the block and reduced “ghost” details can be achieved, or ringing artifacts, which can emerge in the reconstructed block when attempting to preserve texture.

Thus configured, these teachings provide for optimized video encoding, such that a desired level of quality at a desired bit-rate can be attained in a reduced amount of time, with reduced computational requirements, and/or using a reduced bitrate to obtain the desired level of quality, when compared to an encoder which does not utilize these teachings.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

It is to be noted that the examples and embodiments described herein are illustrated as non-limiting examples and should not be construed to limit the presently disclosed subject matter in any way.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable storage medium tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A computerized method of optimized video encoding, the method comprising:
i. receiving a current video frame of an input video sequence to be encoded, the current video frame comprising a plurality of encoding blocks;
ii. encoding the current video frame to generate a corresponding frame bitstream, comprising:
for each encoding block of the plurality of encoding blocks:
a) processing the encoding block using a filter, giving rise to a processed encoding block;
b) computing a residual block as a difference between the encoding block and a corresponding predictor block;
c) performing a frequency transform on the residual block to obtain a transformed residual block constituted by transform coefficients;
d) performing an optimized quantization of the transform coefficients using a modified rate-distortion cost function, giving rise to quantized transform coefficients, wherein the modified rate-distortion cost function is obtained by configuring a reconstruction error in a rate-distortion cost function in accordance with a relation associated with the encoding block and the processed encoding block; and
e) performing entropy encoding of the quantized transform coefficients to obtain a bit sequence corresponding to the encoding block,
thereby giving rise to the frame bitstream comprising a plurality of bit sequences corresponding to the plurality of encoding blocks; and
iii. placing the frame bitstream in an output video stream corresponding to the input video sequence, wherein upon decoding the output video stream, a reconstructed video frame corresponding to the frame bitstream has optimized perceived visual quality as compared to perceived visual quality of a reconstructed video frame of a corresponding frame bitstream which is generated without using the optimized quantization.

2. The computerized method according to claim 1, wherein the processing of the encoding block is performed by applying a filter in pixel domain to the encoding block, and the encoding further comprises:
performing a frequency transform on the encoding block to obtain a transformed encoding block; and
performing a frequency transform on the processed encoding block to obtain a transformed processed encoding block;
wherein the relation is computed as a function of the transformed encoding block and the transformed processed encoding block.

3. The computerized method according to claim 1, wherein the processing of the encoding block is performed by:
performing a frequency transform on the encoding block to obtain a transformed encoding block; and
applying a filter in transform domain to the transformed encoding block to obtain the transformed processed encoding block;
wherein the relation is computed as a function between the transformed encoding block and the transformed processed encoding block.

4. The computerized method according to claim 2, wherein the filter comprises a sharpening filter usable for enhancing one or more features in the encoding block, including edges.

5. The computerized method according to claim 1, wherein the reconstruction error is configured by scaling the reconstruction error by a scaling factor which is dependent on the relation.

6. The computerized method according to claim 2, wherein the reconstruction error is configured by adding a difference value to the reconstruction error, wherein the difference value is calculated by:
calculating a difference between transform coefficients in the transformed encoding block and the corresponding transformed processed encoding block; and
clipping the difference in accordance with a quantizer step size.

7. The computerized method according to claim 1, wherein the relation is a ratio between each transform coefficient in the transformed encoding block and the corresponding transformed processed encoding block.

8. The computerized method according to claim 1, wherein the predictor block is selected from a set of candidate prediction blocks, wherein the set of candidate prediction blocks are pixel blocks from previously encoded and reconstructed pixels belonging either to the current video frame or to a previously processed video frame in the input video sequence, and wherein said selecting is performed so that a rate-distortion cost associated with the predictor block is the lowest among rate-distortion costs associated with the set of candidate prediction blocks.

9. The computerized method according to claim 1, wherein the reconstruction error is indicative of a difference related to the transform coefficients and corresponding de-quantized transform coefficients, and the de-quantized transform coefficients are obtained by multiplying corresponding quantized coefficients by a quantizer step size associated therewith.

10. The computerized method according to claim 1, further comprising repeating said i), ii) and iii) for one or more additional video frames in the input video sequence.

11. A computerized system for optimized video encoding, the system comprising:
an I/O interface configured to receive a current video frame of an input video sequence to be encoded, the current video frame comprising a plurality of encoding blocks; and
a control circuitry operatively connected to the I/O interface, the control circuitry comprising a processor and a memory coupled thereto and configured to:
i. encode the current video frame to generate a corresponding frame bitstream, comprising:
for each encoding block of the plurality of encoding blocks:
a) processing the encoding block using a filter, giving rise to a processed encoding block;
b) computing a residual block as a difference between the encoding block and a corresponding predictor block;
c) performing a frequency transform on the residual block to obtain a transformed residual block constituted by transform coefficients;
d) performing an optimized quantization of the transform coefficients using a modified rate-distortion cost function, giving rise to quantized transform coefficients, wherein the modified rate-distortion cost function is obtained by configuring a reconstruction error in a rate-distortion cost function in accordance with a relation associated with the encoding block and the processed encoding block; and
e) performing entropy encoding of the quantized transform coefficients to obtain a bit sequence corresponding to the encoding block,
thereby giving rise to the frame bitstream comprising a plurality of bit sequences corresponding to the plurality of encoding blocks; and
ii. place the frame bitstream in an output video stream corresponding to the input video sequence, wherein upon decoding the output video stream, a reconstructed video frame corresponding to the current video frame has optimized perceived visual quality as compared to perceived visual quality of a reconstructed video frame of a corresponding frame bitstream which is generated without using the optimized quantization.

12. The computerized system according to claim 11, wherein the control circuitry is configured to process the encoding block by applying a filter in pixel domain to the encoding block, and the encoding further comprises:
performing a frequency transform on the encoding block to obtain a transformed encoding block; and
performing a frequency transform on the processed encoding block to obtain a transformed processed encoding block;
wherein the relation is computed as a function of the transformed encoding block and the transformed processed encoding block.

13. The computerized system according to claim 11, wherein the control circuitry is configured to process the encoding block by:
performing a frequency transform on the encoding block to obtain a transformed encoding block; and
applying a filter in transform domain to the transformed encoding block to obtain the transformed processed encoding block;
wherein the relation is computed as a function between the transformed encoding block and the transformed processed encoding block.

14. The computerized system according to claim 12, wherein the filter comprises a sharpening filter usable for enhancing one or more features in the encoding block, including edges.

15. The computerized system according to claim 11, wherein the reconstruction error is configured by scaling the reconstruction error by a scaling factor which is dependent on the relation.

16. The computerized system according to claim 12, wherein the reconstruction error is configured by adding a difference value to the reconstruction error, wherein the difference value is calculated by:
calculating a difference between transform coefficients in the transformed encoding block and the corresponding transformed processed encoding block; and
clipping the difference in accordance with a quantizer step size.

17. The computerized system according to claim 11, wherein the relation is a ratio between each transform coefficient in the transformed encoding block and the corresponding transformed processed encoding block.

18. The computerized system according to claim 11, wherein the predictor block is selected from a set of candidate prediction blocks, wherein the set of candidate prediction blocks are pixel blocks from previously encoded and reconstructed pixels belonging either to the current video frame or to a previously processed video frame in the input video sequence, and wherein said selecting is performed so that a rate-distortion cost associated with the predictor block is the lowest among rate-distortion costs associated with the set of candidate prediction blocks.

19. The computerized system according to claim 11, wherein the control circuitry is further configured to repeat said i), ii) for one or more additional video frames in the input video sequence.

20. A non-transitory computer readable storage medium tangibly embodying a program of instructions that, when executed by a computer, cause the computer to perform a method of optimized video encoding, the method comprising:
i. receiving a current video frame of an input video sequence to be encoded, the current video frame comprising a plurality of encoding blocks;
ii. encoding the current video frame to generate a corresponding frame bitstream, comprising:
for each encoding block of the plurality of encoding blocks:
a) processing the encoding block using a filter, giving rise to a processed encoding block;
b) computing a residual block as a difference between the encoding block and a corresponding predictor block;
c) performing a frequency transform on the residual block to obtain a transformed residual block constituted by transform coefficients;
d) performing an optimized quantization of the transform coefficients using a modified rate-distortion cost function, giving rise to quantized transform coefficients, wherein the modified rate-distortion cost function is obtained by configuring a reconstruction error in a rate-distortion cost function in accordance with a relation associated with the encoding block and the processed encoding block; and
e) performing entropy encoding of the quantized transform coefficients to obtain a bit sequence corresponding to the encoding block,
thereby giving rise to the frame bitstream comprising a plurality of bit sequences corresponding to the plurality of encoding blocks; and
iii. placing the frame bitstream in an output video stream corresponding to the input video sequence, wherein upon decoding the output video stream, a reconstructed video frame corresponding to the frame bitstream has optimized perceived visual quality as compared to perceived visual quality of a reconstructed video frame of a corresponding frame bitstream which is generated without using the optimized quantization.
